(19) United States
(12) Patent Application Publication
(10) Pub. No.: US 2026/0170560 A1
(43) Pub. Date: Jun. 18, 2026

(54) SYSTEMS, PROCESSORS, AND METHODS FOR MANAGING USER FINANCIAL INFORMATION

(71) Applicant: DBS Bank Ltd, Singapore (SG)

(72) Inventors: Jun LI, Singapore (SG); Xiecheng GU, Singapore (SG); Tong Kai Alvin KOH, Singapore (SG)

(73) Assignee: DBS Bank Ltd, Singapore (SG)

(21) Appl. No.: 18/710,646

(22) PCT Filed: Apr. 4, 2023
(86) PCT No.: PCT/SG2023/050225

§ 371 Date: May 16, 2024

(51) Int. Cl. G06Q 40/06

(52) U.S. Cl. CPC G06Q 40/066

(57) ABSTRACT

Embodiments relate to methods and systems for managing user financial information. The method includes performing a main financial institution processing, which includes generating an inflow and outflow of value into and out of all financial accounts held by the user in at least a first and second financial institution, generating an inflow/outflow ratio, identifying all recurring and non-recurring payments made by all financial accounts held in the first and second financial institution, and generating a financial institution score based on at least one of the above. The method includes determining a financial institution ranking, determined by comparing the financial institution scores and ranking based on the comparing. The method includes generating product recommendation(s) based on the financial institution score(s) and/or the financial institution ranking.

### TECHNICAL FIELD

The present disclosure relates generally to systems, processors and methods for managing user financial information. More specifically, present example embodiments relate to systems, processors and methods for generating, among other things, personalized financial product recommendations and top picks for users.

### BACKGROUND

Many first-world countries are facing ageing populations. With humans having increasing life expectancy, and many hit hard by various setbacks such as pandemics and economic recession, more and more people are in need of assistance to achieve financial independence and improve their financial literacy, regardless of their socio-economic status. Many people have difficulties in having a holistic overview of finances, and ensuring their needs are protected and they have adequate and appropriate coverage, and fail to plan for their retirement. Additionally, many people do not have access to proper investment guidance which results in no or poor investments.

Various financial institutions and fintech companies have made attempts to solve the aforementioned problems. One such attempt is the development of systems and methods focusing on investments or savings only. However, these systems and methods do not address both investments and savings, and also fail to address issues across the financial planning spectrum including budgeting, protecting, and long term goals. Another attempt is the development of systems and methods focusing on investment, insurance, or savings product solutions. However, these systems and methods do not provide any assistance in financial planning.

### SUMMARY

With increasing inflation, it is increasingly important for people to have adequate financial planning and coverage. Financial planning and coverage includes having a good overview of all of one's financial information (e.g., assets and liabilities, cashflow, investment holdings, protection plans, etc.), holding appropriate products for one's needs (e.g., insurance plan with adequate coverage given their life stage or situation), insight into how well one's financial planning is going, and/or established goals and plans for the future. As advances in technology increase and quicken, so should financial planning resources and platforms. For example, there are presently a multitude of financial platforms focusing on only one or two aspects of financial planning, such as savings only or investment only. Many current avenues to access financial advice is also confusing, complicated, difficult, or the like. This makes it difficult for users to have an adequate overview of all their finances and easily manage their finances, products, and goals, and receive advice or recommendations for financial planning.

Present example embodiments relate generally to and/or include systems, subsystems, processors, devices, logic, methods, and processes for addressing conventional problems, including those described above and in the present disclosure, and more specifically, example embodiments relate to systems, subsystems, processors, devices, logic, methods, and processes for managing user financial information, including generating, among other things, personalized financial product recommendations and top picks for users.

In an exemplary embodiment, a method of managing user financial information is described. The method includes performing a main financial institution processing, the main financial institution processing including searching, for a first user, all financial institutions in which the first user has at least one financial account, including a first financial institution and a second financial institution.

The main financial institution processing also includes, for each of the financial institutions located by the search, generating a total inflow of value into all financial accounts held by the first user for a first period of time, generating a total outflow of value of all financial accounts held by the first user for the first period of time, generating an inflow/outflow ratio for the first user for the first period of time based on the generated total inflow of value and the generated total outflow of value, identifying all recurring payments made by all financial accounts held by the first user for the first time period, identifying all non-recurring payments made by all financial accounts held by the first user for the first time period, generating a financial institution score for the first user based on at least one of the inflow/outflow ratio, and determining a financial institution ranking for the first user for the first period of time.

The generating of a total inflow of value into all financial accounts held by the first user for a first period of time includes a first total inflow of value and a second total inflow of value, the first total inflow of value being the total inflow of value into all financial accounts held by the first user in the first financial institution for the first period of time, the second total inflow of value being the total inflow of value into all financial accounts held by the first user in the second financial institution for the first period of time. The generating of generating a total outflow of value out of all financial accounts held by the first user for the first period of time includes a first total outflow of value and a second total outflow of value, the first total outflow of value being the total outflow of value out of all financial accounts held by the first user in the first financial institution for the first period of time, the second total outflow of value being the total outflow of value out of all financial accounts held by the first user in the second financial institution for the first period of time. The generating of an inflow/outflow ratio for the first user for the first period of time based on the generated total inflow of value and the generated total outflow of value includes a first inflow/outflow ratio and a second inflow/outflow ratio, the first inflow/outflow ratio being a ratio of the first total inflow of value to the first total outflow of value, the second inflow/outflow ratio being a ratio of the second total inflow of value to the second total outflow of value. The identifying of all recurring payments made by all financial accounts held by the first user for the first time period includes a first set of recurring payments and a second set of recurring payments, the first set of recurring payments being all recurring payments made by all financial accounts held by the first user in the first financial institution for the first period of time, the second set of recurring payments being all recurring payments made by all financial accounts held by the first user in the second financial institution for the first period of time. The identifying of all non-recurring payments made by all financial accounts held by the first user for the first time period includes a first set of non-recurring payments and a second set of non-recurring payments, the first set of non-recurring payments being all non-recurring payments made by all financial accounts held by the first user in the first financial institution for the first period of time, the second set of non-recurring payments being all non-recurring payments made by all financial accounts held by the first user in the second financial institution for the first period of time. The generating of a financial institution score for the first user based on at least one of the inflow/outflow ratio, the identified recurring payments, and the non-recurring payments includes a first financial institution score and a second financial institution score, wherein the first financial institution score is generated based on at least one of the first inflow/outflow ratio, the first set of recurring payments, and the first set of non-recurring payments, wherein the second financial institution score is generated based on at least one of the second inflow/outflow ratio, the second set of recurring payments, and the second set of non-recurring payments. The determining of a financial institution ranking for the first user for the first period of time includes the ranking of the financial institution for the first user for the first time period being determined by comparing the financial institution score for each of the financial institutions located by the search, including the first financial institution score and the second financial institution score and ranking the financial institutions located by the search based on the comparing.

The method of managing user financial information also includes generating one or more product recommendations for the first user, the one or more product recommendations for the first user generated based on at least one of the following: one or more of the financial institution scores generated for the first user, and the financial institution ranking for the first user.

In another exemplary embodiment, a method of managing user financial information is described. The method includes performing a main financial institution processing for a first user, the main financial institution processing for the first user, including searching, for the first user, all financial institutions in which the first user has at least one financial account, including a first financial institution and a second financial institution. The main financial institution processing also includes, for each of the financial institutions located by the search, performing at least one of the following: generating an inflow/outflow ratio for the first user for a first period of time, identifying all recurring payments made by all financial accounts held by the first user for the first time period, and identifying all non-recurring payments made by all financial accounts held by the first user for the first time period.

The generating of an inflow/outflow ratio for the first user for a first period of time includes generating a total inflow of value into all financial accounts held by the first user for the first period of time, including a first total inflow of value and a second total inflow of value, the first total inflow of value being the total inflow of value into all financial accounts held by the first user in the first financial institution for the first period of time, the second total inflow of value being the total inflow of value into all financial accounts held by the first user in the second financial institution for the first period of time. The generating of an inflow/outflow ratio for the first user for a first period of time also includes generating a total outflow of value out of all financial accounts held by the first user for the first period of time, including a first total outflow of value and a second total outflow of value, the first total outflow of value being the total outflow of value out of all financial accounts held by the first user in the first financial institution for the first period of time, the second total outflow of value being the total outflow of value out of all financial accounts held by the first user in the second financial institution for the first period of time. The generating of an inflow/outflow ratio for the first user for a first period of time also includes generating the inflow/outflow ratio for the first user for the first period of time based on the generated total inflow of value and the generated total outflow of value, including a first inflow/outflow ratio and a second inflow/outflow ratio, the first inflow/outflow ratio being a ratio of the first total inflow of value to the first total outflow of value, the second inflow/outflow ratio being a ratio of the second total inflow of value to the second total outflow of value.

The identifying of all recurring payments made by all financial accounts held by the first user for the first time period includes a first set of recurring payments and a second set of recurring payments, the first set of recurring payments being all recurring payments made by all financial accounts held by the first user in the first financial institution for the first period of time, the second set of recurring payments being all recurring payments made by all financial accounts held by the first user in the second financial institution for the first period of time.

The identifying of all non-recurring payments made by all financial accounts held by the first user for the first time period includes a first set of non-recurring payments and a second set of non-recurring payments, the first set of non-recurring payments being all non-recurring payments made by all financial accounts held by the first user in the first financial institution for the first period of time, the second set of non-recurring payments being all non-recurring payments made by all financial accounts held by the first user in the second financial institution for the first period of time.

The main financial institution processing for a first user also includes determining a financial institution ranking for the first user for the first period of time. The ranking of the financial institution for the first user for the first time period is determined by comparing the financial institution score for each of the financial institutions located by the search, including the first financial institution score and the second financial institution score and ranking the financial institutions located by the search based on the comparing.

The method for managing user financial information also includes generating one or more product recommendations for the first user, the one or more product recommendations for the first user generated based on at least one of the following: one or more of the financial institution scores generated for the first user, and the financial institution ranking for the first user.

In another exemplary embodiment, a method of managing user financial information is described. The method includes receiving user data for a first user, performing a main financial institution processing, generating a digital value capture score for the first user, generating a product propensity score for the first user, generating a real-time financial product information for one or more financial products, generating a financial personality of the first user, and generating one or more product recommendations for the first user.

The receiving of user data for the first user includes at least one of the following: one or more customer declared information of the first user, the one or more customer declared information of the first user including information provided by the first user, one or more financial institution information of the first user, the one or more financial institution information of the first user including information obtainable from one or more financial accounts of one or more financial institutions held by the first user, one or more social media information of the first user, the one or more social media information of the first user including information obtainable from one or more social media accounts held by the first user, and one or more personal preference information of the first user, the one or more personal preference information of the first user including financial goals, financial objectives, life stages of the first user, financial stages of the first user, and financial preference of the first user.

The performing of a main financial institution processing includes searching, for a first user, all financial institutions in which the first user has at least one financial account, including a first financial institution and a second financial institution. The performing of a main financial institution processing includes, for each of the financial institutions located by the search, generating a total inflow of value into all financial accounts held by the first user for a first period of time, including a first total inflow of value and a second total inflow of value, the first total inflow of value being the total inflow of value into all financial accounts held by the first user in the first financial institution for the first period of time, the second total inflow of value being the total inflow of value into all financial accounts held by the first user in the second financial institution for the first period of time, generating a total outflow of value out of all financial accounts held by the first user for the first period of time, including a first total outflow of value and a second total outflow of value, the first total outflow of value being the total outflow of value out of all financial accounts held by the first user in the first financial institution for the first period of time, the second total outflow of value being the total outflow of value out of all financial accounts held by the first user in the second financial institution for the first period of time, generating an inflow/outflow ratio for the first user for the first period of time based on the generated total inflow of value and the generated total outflow of value, including a first inflow/outflow ratio and a second inflow/outflow ratio, the first inflow/outflow ratio being a ratio of the first total inflow of value to the first total outflow of value, the second inflow/outflow ratio being a ratio of the second total inflow of value to the second total outflow of value, identifying all recurring payments made by all financial accounts held by the first user for the first period of time, including a first set of recurring payments and a second set of recurring payments, the first set of recurring payments being all recurring payments made by all financial accounts held by the first user in the first financial institution for the first period of time, the second set of recurring payments being all recurring payments made by all financial accounts held by the first user in the second financial institution for the first period of time, identifying all non-recurring payments made by all financial accounts held by the first user for the first period of time, including a first set of non-recurring payments and a second set of non-recurring payments, the first set of non-recurring payments being all non-recurring payments made by all financial accounts held by the first user in the first financial institution for the first period of time, the second set of non-recurring payments being all non-recurring payments made by all financial accounts held by the first user in the second financial institution for the first period of time, and generating a financial institution score for the first user based on at least one of the inflow/outflow ratio, the identified recurring payments, and the non-recurring payments, including a first financial institution score and a second financial institution score, wherein the first financial institution score is generated based on at least one of the first inflow/outflow ratio, the first set of recurring payments, and the first set of non-recurring payments, wherein the second financial institution score is generated based on at least one of the second inflow/outflow ratio, the second set of recurring payments, and the second set of non-recurring payments.

The performing of a main financial institution processing also includes determining a financial institution ranking for the first user for the first period of time, the ranking financial institution for the first user for the first time period determined by comparing the financial institution score for each of the financial institutions located by the search, including the first financial institution score and the second financial institution score, and ranking the financial institutions located by the search based on the comparing.

The generating of a digital value capture score for the first user, the digital value capture score for the first user representing the first user's preference in being engaged digitally, includes being generated based on at least one of the following: one or more transactions made by the first user, one or more channels used by the first user, one or more investment products purchased by the first user, number of times the first user used digital channels, number of times the first user used non-digital channels, number of times the first user interacted based on digital communications, number of times the first user interacted based on non-digital communications.

The generating of a product propensity score for the first user, the product propensity score for the first user representing the first user's likely interest in one or more financial products, includes being generated based on at least one of the following: CASA balance, one or more of the financial institution scores, balances of one or more financial accounts held by the first user, income of the first user.

The generating of real-time financial product information for one or more financial products includes being generated based on at least one of the following: product tenor, product risk rating, level of sophistication of the financial product, financial objective of the financial product, risk capacity assessment of the financial product, conviction rating of the financial product.

The generating of a financial personality of the first user, the financial personality of the first user being a psychometric assessment of the first user to determine personality and/or behavioral traits on different aspects of financial planning of the first user, includes being generated based on at least one of the following: savings personality of the first user, spending personality of the first user, investment personality of the first user, protection personality of the first user, and debt personality of the first user.

The generating of one or more financial product recommendations for the first user includes being generated based on the following: one or more of the financial institution scores generated for the first user and/or the financial institution ranking for the first user, the user data for the first user, the digital value capture score for the first user, the product propensity score for the first user, the real-time financial product information for one or more financial products, and the financial personality of the first user.

### BRIEF DESCRIPTION OF THE FIGURES

For a more complete understanding of the present disclosure, example embodiments, and their advantages, reference is now made to the following description taken in conjunction with the accompanying figures, in which like reference numbers indicate like features, and:

FIG. 1 is an illustration of an example embodiment of a system for managing user financial information;

FIG. 2 is an illustration of an example embodiment of a processor for managing user financial information;

FIG. 3 is an illustration of an example embodiment of a user data processor;

FIG. 4 is an illustration of an example embodiment of a financial product processor; and

FIG. 5 is an illustration of an example embodiment of a top picks generator.

Although similar reference numbers may be used to refer to similar elements in the figures for convenience, it can be appreciated that each of the various example embodiments may be considered to be distinct variations.

Example embodiments will now be described with reference to the accompanying figures, which form a part of the present disclosure and which illustrate example embodiments which may be practiced. As used in the present disclosure and the appended claims, the terms “embodiment”, “example embodiment”, “exemplary embodiment”, and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on”, and the terms “a”, “an”, and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon”, depending on the context. Furthermore, as used in the present disclosure and the appended claims, the words “and/or” may refer to and encompass any and all possible combinations of one or more of the associated listed items.

### DETAILED DESCRIPTION

Present example embodiments relate generally to and/or include systems, subsystems, processors, devices, logic, methods, and processes for addressing conventional problems with providing recommendations to users for, among other things, financial products and services (referred to herein as “financial products”, “financial services”, “products” or “services”), including those described above and in the present disclosure. As used in the present disclosure, when applicable, a reference to a “user” may also refer to, apply to, and/or include one or more human users, businesses, companies, corporations, departments, entities, and/or the like

For example, present example embodiments are configurable or configured to search for, identify, select, compile, generate, transform, process, assess, and/or otherwise receive user data.

Such user data may include, but is not limited to, customer declared data, financial institution information (e.g., information on financial institutions used by each user, etc.), which financial institution may be a main financial institution of the user (as further described in the present disclosure), social media information (e.g., which social media platforms/services are used by each user, social media information of each user from such platforms, etc.), digital value capture information (e.g., information representing each users' preferences in being engaged digitally, virtually, etc.), product propensity (e.g., likely interest for each user in one or more financial products, services, groups, etc.), and personal preferences (e.g., financial goals and objectives, life stages, financial stages, financial preference information (e.g., level of effort, risk capacity, etc.), geographical information, etc.).

Example embodiments are also configurable or configured to search for, identify, select, compile, generate, transform, process, assess, and/or otherwise receive financial product data. Such financial product data may include, but is not limited to, product tenor (e.g., amount of time until maturity for fixed lifespan financial products, investment framework (e.g., amount of time for active trading of unit trusts, etc.), etc.), product risk rating (e.g., risks based on risk of loss of product and complexities of the product), sophisticated product indicator (e.g., 6-point alphabetical scale of N, A, B, C, D, and E, wherein “N” indicates that a product is simple and free of derivatives, “A” denotes the least complexity and “E” denotes the most complex product), financial objective for the financial product, financial preference information (e.g., level of effort, risk capacity, etc.), and conviction rating (e.g., rating of likelihood of performance of the financial product relative to peers, against the same asset class and/or benchmark, over the next period of time (e.g., 18 months, 36 months, etc.), etc.).

Example embodiments are also configurable or configured to search for, identify, select, compile, generate, transform, process, assess, and/or otherwise receive financial personality information. Such financial personality information may include, but is not limited to, savings personality (e.g., attitudes towards savings, types of motivators for savings, savings tendencies and behaviours, etc.), spending personality (e.g., attitudes towards spending, types of motivators for spending, spending tendencies and behaviours, etc.), investment personality (e.g., attitudes towards investing, types of motivators for investing, investment tendencies and behaviours, etc.), protection personality (e.g., attitudes towards protection (e.g., insurance), types of motivators for protection, protection tendencies and behaviours, etc.), and debt personality (e.g., attitudes towards borrowing and repayment, types of motivators for borrowing and repayment, borrowing and repaying tendencies and behaviours, etc.).

Example embodiments are also configurable or configured to search for, identify, compile, generate, transform, process, assess, and/or otherwise select product recommendations for users. Such product recommendations for each user may be generated based on, among other things, customer declared data of the user, information from financial institutions of the user, social media information of the user, a determination of a main financial institution of the user (e.g., main financial institution score of the user, as further described in the present disclosure), a determination of a digital value capture of the user (e.g., digital value capture score of the user, as further described in the present disclosure), a determination of product propensity of the user (e.g., product propensity score of the user, as further described in the present disclosure), personal preferences of the user, financial product information (e.g., real time financial product data), and/or financial personality of the user.

Example embodiments are also configurable or configured to search for, identify, compile, generate, transform, process, assess, and/or otherwise select top picks of financial products for users. Such top picks each user may be generated based on, among other things, selecting one or more product recommendations (e.g., as generated by the product recommendations processor 600) based on customer look-like assessments (e.g., as assessed and selected by the customer look-like processor 710), customer propensity assessments (e.g., as assessed and selected by the customer propensity processor 720), and/or product look-like assessments (e.g., as assessed and selected by the product look-like processor 730).

To perform the actions, functions, processes, and/or methods described above and in the present disclosure, example embodiments include a system (e.g., system 100) for managing user financial information. The system 100, when configured, may include one or more elements. For example, the system 100 may include one or more users 10. The system 100 may also include one or more databases/data storage/blockchains/etc. 20. The system 100 may also include one or more information sources 30 (e.g., government entities 30, pseudo-government entities 30, industry/financial/regulatory/etc. governing bodies 30, financial institutions 30 and banks 30, digital banks 30, FinTech organizations 30, cryptocurrency providers/exchanges/banks/etc. 30, insurance organizations 30, assurance organizations 30, social media platforms 30, social media systems 30, social media networks 30, search engines 30, telecommunications organizations 30, transportation organizations 30, multimedia organizations 30, etc.). The system 100 may also include one or more networks/internet/cloud computing/web/public clouds/private clouds/etc. 50. The system 100 may also include one or more financial processors (e.g., financial processors 200, or also referred to herein as processors 200).

Example embodiments will now be described below with reference to the accompanying figures, which form a part of the present disclosure.

### Example Embodiments of a System for Managing User Financial Information (e.g., System 100).

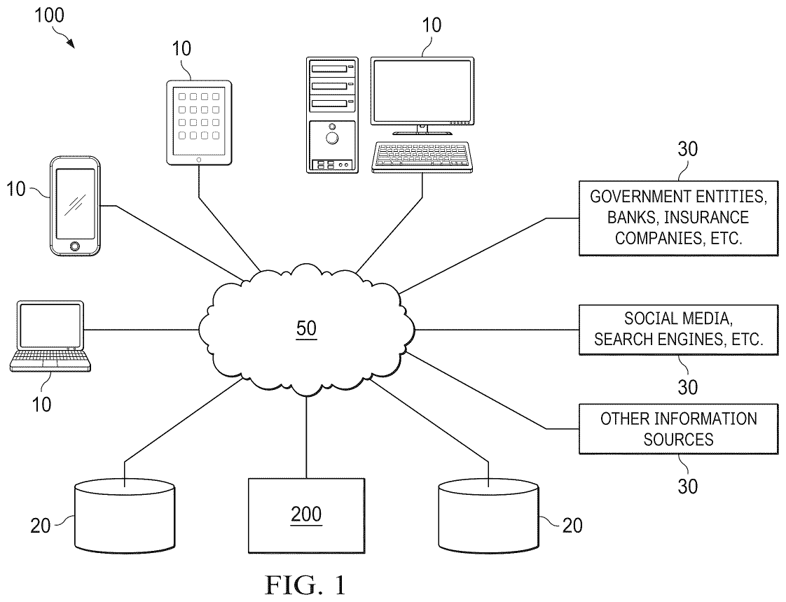

FIG. 1 illustrates an example embodiment of a system (e.g., system 100) for managing financial information for one or more users 10. The system 100 is configurable or configured to search for, identify, select, compile, generate, transform, process, assess, and/or otherwise receive user data for each user 10. Alternatively or in addition, the system 100 is configurable or configured to search for, identify, select, compile, generate, transform, process, assess, and/or otherwise receive financial product data. Alternatively or in addition, the system 100 is configurable or configured to search for, identify, select, compile, generate, transform, process, assess, and/or otherwise receive financial personality information for each user 10. Alternatively or in addition, the system 100 is configurable or configured to search for, identify, compile, generate, transform, process, assess, and/or otherwise select product recommendations (of financial products) for each user 10. Alternatively or in addition, the system 100 is configurable or configured to search for, identify, compile, generate, transform, process, assess, and/or otherwise select top picks (of financial products) for each user 10.

Example embodiments of the system 100 are configurable or configured to perform these and other functions, actions, and/or processes, including those described in the present disclosure, via one or more elements of the system 100. For example, the system 100 may include one or more users 10. The system 100 may also include one or more databases 20, data storage systems 20, blockchains 20, other distributed ledger technology (DLT) 20, etc. The system 100 may also include one or more information sources 30 (e.g., information directly or indirectly from government entities 30, pseudo-government entities 30, industry/financial/regulatory/etc. governing bodies 30, financial institutions 30 and banks 30, digital banks 30, FinTech organizations 30, cryptocurrency providers/exchanges/banks/etc. 30, insurance organizations 30, assurance organizations 30, social media platforms 30, social media systems 30, social media networks 30, search engines 30, telecommunications organizations 30, transportation organizations 30, multimedia organizations 30, artificial engine (AI) systems 30, quantum computing systems 30, etc.). The system 100 may also include one or more networks 50, the internet 50, cloud computing 50, the World Wide Web 50 (including Web 1.0, Web 2.0, Web 3.0, etc.), public clouds 50, private clouds 50, etc. The system 100 may also include one or more financial processors or processors (e.g., processor 200).

Example embodiments of the system 100 will now be described below with reference to the accompanying figures, which form a part of the present disclosure.

### The Financial Processor (e.g., Processor 200).

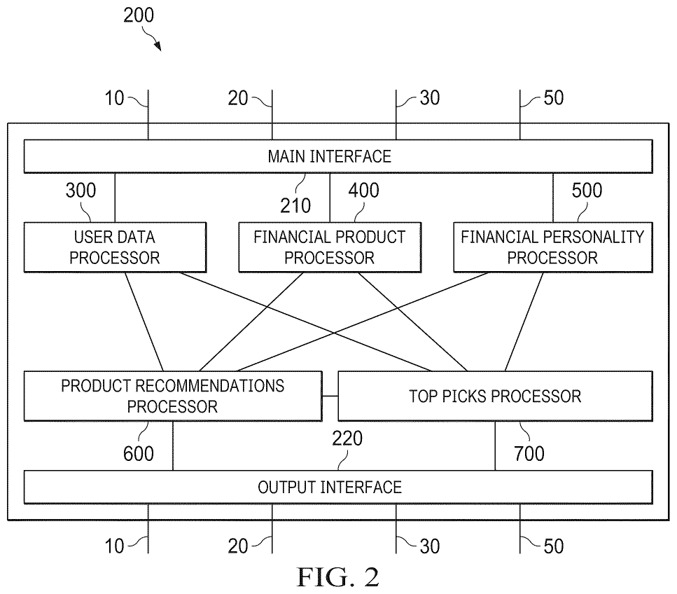

As illustrated in FIG. 1 and FIG. 2, an example embodiment of the system 100 includes a financial processor (e.g., processor 200, also referred to herein as a “processor”). Each processor 200 is configurable or configured to perform a variety of actions, functions, methods, and/or processes, including managing of user financial information.

Each processor 200 may include one or more elements configurable or configured to perform a variety of actions, functions, methods, and/or processes, including the managing of user financial information. For example, each processor 200 may include one or more main interfaces (e.g., main interface 210) configurable or configured to search for, identify, select, compile, generate, transform, process, assess, and/or otherwise receive information and/or requests (e.g., requests received from one or more users 10 for product recommendations, request for top picks, etc.) from one or more users 10, one or more databases 20, one or more information sources 30, one or more networks 50, and/or one or more other systems 100 and/or processors 200. Such information are then provided to one or more other elements of the system 100 including, but not limited to, the user data processor 300, the financial product processor 400, the financial personality processor 500, the product recommendations processor 600, the top picks processor 700, and/or the output interface 220.

Each processor 200 may also include one or more user data processors (e.g., user data processor 300). The user data processor 300 is configurable or configured to process user data received from the main interface 210. Such user data may include, but is not limited to, customer declared data, financial institution information, which financial institution(s) may be a main financial institution of the user 10, social media information of the user 10, social media information of the user 10, digital value capture information of the user 10, product propensity of the user 10, and personal preferences of the user 10. Such user data are then provided to one or more other elements of the system 100 including, but not limited to, the product recommendations processor 600, the top picks processor 700, and/or the output interface 220.

Each processor 200 may also include one or more financial product processors (e.g., financial product processor 400). The financial product processor 400 is configurable or configured to process financial product data received from the main interface 210. Such financial product data may include, but is not limited to, product tenor information, product risk rating information, sophisticated product indicator information, financial objective information for the financial product, information regarding financial preference information, and conviction rating information. Such financial product data are then provided to one or more other elements of the system 100 including, but not limited to, the product recommendations processor 600, the top picks processor 700, and/or the output interface 220.

Each processor 200 may also include one or more financial personality processors (e.g., financial personality processor 500). The financial personality processor 500 is configurable or configured to process financial personality data received from the main interface 210. Such financial personality data may include, but is not limited to, savings personality information of the user 10, spending personality information of the user 10, investment personality information of the user 10, protection personality information of the user 10, and/or debt personality information of the user 10.

Such financial personality data are then provided to one or more other elements of the system 100 including, but not limited to, the product recommendations processor 600, the top picks processor 700, and/or the output interface 220.

Each processor 200 may also include one or more product recommendation processors (e.g., product recommendation processor 600). The product recommendation processor 600 is configurable or configured to process information received from the main interface 210, the user data processor 300, the financial product processor 400, the financial personality processor 500, and/or the top picks processor 700. Once received, the product recommendation processor 600 is then configurable or configured to generate one or more product recommendations for one or more users 10. Such product recommendations are then provided to one or more other elements of the system 100 including, but not limited to, the top picks processor 700 and/or the output interface 220.

Each processor 200 may also include one or more top picks processors (e.g., top picks processor 700). The top picks processor 700 is configurable or configured to process information received from the main interface 210, the user data processor 300, the financial product processor 400, the financial personality processor 500, and/or the product recommendations processor 600.

Once received, the top picks processor 700 is then configurable or configured to generate one or more top picks (of financial products) for one or more users 10. Such top picks are then provided to one or more other elements of the system 100 including, but not limited to, the product recommendations processor 700 and/or the output interface 220.

Although the figures may illustrate the processor 200 as having one main interface 210, one user data processor 300, one financial product processor 400, one financial personality processor 500, one product recommendations processor 600, one top picks processor 700, and one output interface 220, it is to be understood that the processor 200 may include more or less than one main interface 210, more or less than one user data processor 300, more or less than one financial product processor 400, more or less than one financial personality processor 500, more or less than one product recommendations processor 600, more or less than one top picks processor 700, and/or more or less than one output interface 220 without departing from the teachings of the present disclosure. For example, the processor 200 may include one or more main interfaces 210 configurable or configured to perform some, most, and/or all of the functions of the main interface 210, user data processor 300, financial product processor 400, financial personality processor 500, product recommendations processor 600, top picks processor 700, and/or output interface 220. As another example, the processor 200 may include one or more user data processors 300 configurable or configured to perform some, most, and/or all of the functions of the main interface 210, user data processor 300, financial product processor 400, financial personality processor 500, product recommendations processor 600, top picks processor 700, and output interface 220. As another example, the processor 200 may include one or more financial product processors 400 configurable or configured to perform some, most, and/or all of the functions of the main interface 210, user data processor 300, financial product processor 400, financial personality processor 500, product recommendations processor 600, top picks processor 700, and output interface 220. As another example, the processor 200 may include one or more financial personality processors 500 configurable or configured to perform some, most, and/or all of the functions of the main interface 210, user data processor 300, financial product processor 400, financial personality processor 500, product recommendations processor 600, top picks processor 700, and output interface 220. As another example, the processor 200 may include one or more product recommendations processors 600 configurable or configured to perform some, most, and/or all of the functions of the main interface 210, user data processor 300, financial product processor 400, financial personality processor 500, product recommendations processor 600, top picks processor 700, and output interface 220. In yet another example, the processor 200 may include one or more top picks processors 700 configurable or configured to perform some, most, and/or all of the functions of the main interface 210, user data processor 300, financial product processor 400, financial personality processor 500, product recommendations processor 600, top picks processor 700, and output interface 220. As another example, the processor 200 may include one or more output interfaces 220 configurable or configured to perform some, most, and/or all of the functions of the main interface 210, user data processor 300, financial product processor 400, financial personality processor 500, product recommendations processor 600, top picks processor 700, and output interface 220. Each of the elements of the processor 200 may be configurable or configured to connect to, communicate with, and/or receive communications (including requests) from one or more users 10, one or more computing devices 10, one or more databases 20, one or more information sources 30, one or more networks 50, and/or one or more other systems 100 and/or processors 200.

As used in the present disclosure, when applicable, a reference to a “system”, “processor”, system 100 (and/or one of its elements), financial processor 200 (and/or one of its elements), processor 200 (and/or one of its elements), main interface 210 (and/or one of its elements), user data processor 300 (and/or one of its elements), financial product processor 400 (and/or one of its elements), financial personality processor 500 (and/or one of its elements), product recommendations processor 600 (and/or one of its elements), top picks processor 700 (and/or one of its elements), and output interface 220 (and/or one of its elements) may also refer to, apply to, and/or include one or more computing devices, processors, servers, systems, cloud-based computing, virtual machines, AI machines, or the like, and/or functionality of one or more processors, computing devices, servers, systems, cloud-based computing, virtual machines, AI machines, or the like. The “system”, “processor”, system 100 (and/or one of its elements), financial processor 200 (and/or one of its elements), processor 200 (and/or one of its elements), main interface 210 (and/or one of its elements), user data processor 300 (and/or one of its elements), financial product processor 400 (and/or one of its elements), financial personality processor 500 (and/or one of its elements), product recommendations processor 600 (and/or one of its elements), top picks processor 700 (and/or one of its elements), and output interface 220 (and/or one of its elements) may be any processor, server, system, device, computing device, controller, microprocessor, microcontroller, microchip, semiconductor device, or the like, configurable or configured to perform the actions, steps, methods, processes, and/or the like, described in the present disclosure. Alternatively or in addition, the “system”, “processor”, system 100 (and/or one of its elements), financial processor 200 (and/or one of its elements), processor 200 (and/or one of its elements), main interface 210 (and/or one of its elements), user data processor 300 (and/or one of its elements), financial product processor 400 (and/or one of its elements), financial personality processor 500 (and/or one of its elements), product recommendations processor 600 (and/or one of its elements), top picks processor 700 (and/or one of its elements), and output interface 220 (and/or one of its elements) may include and/or be a part of a virtual machine, processor, computer, node, instance, host, or machine, including those in a networked computing environment. Furthermore, the terms “data” and “information” may be used interchangeably in the present disclosure to refer to data and/or information without departing from the teachings of the present disclosure.

As used in the present disclosure, a communication channel 50, network 50, cloud 50, or the like, may be or include a collection of devices and/or virtual machines connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A communication channel 50, network 50, cloud 50, or the like, may include, but is not limited to, computing grid systems, peer to peer systems, mesh-type systems, distributed computing environments, cloud computing environment, telephony systems, voice over IP (VOIP) systems, voice communication channels, voice broadcast channels, text-based communication channels, video communication channels, etc. Such communication channels 50, networks 50, clouds 50, or the like, may include hardware and software infrastructures configured to form a virtual organization comprised of multiple resources which may be in geographically disperse locations. Communication channel 50, network 50, cloud 50, or the like, may also refer to a communication medium between processes on the same device. Also as referred to herein, a network element, node, or server may be a device deployed to execute a program operating as a socket listener and may include software instances.

It is to be understood in the present disclosure that one or more elements, actions, and/or aspects of example embodiments may include and/or implement, in part or in whole, solely and/or in cooperation with other elements, using, for example, networking technologies, cloud computing, distributed ledger technology (DLT) (e.g., blockchain), artificial intelligence (AI), machine learning, deep learning, etc. Furthermore, although example embodiments described in the present disclosure may be directed to the managing user financial information, it is to be understood in the present disclosure that example embodiments may also be directed to the managing of user non-financial information without departing from the teachings of the present disclosure.

These and other elements of the processor 200 will now be further described with reference to the accompanying figures.

### The Main Interface (e.g., Main Interface 210).

As illustrated in at least FIG. 2, the processor 200 includes and/or communicates with one or more main interfaces (e.g., main interface 210). Each main interface is configurable or configured to search for, identify, select, compile, generate, transform, process, assess, and/or otherwise receive information and/or requests (e.g., requests received from one or more users 10 for product recommendations, request for top picks, etc.) from one or more elements of the system 100, including one or more users 10, one or more databases 20, one or more information sources 30, one or more networks 50, and/or one or more other system 100 and/or processors 200.

Information received by the main interface 210 may include, but is not limited to, user data. User data may include customer declared data, financial institution information (e.g., information on financial institutions used by each user 10, etc.), which financial institution may be a main financial institution of the user 10 (as further described in the present disclosure), social media information (e.g., which social media platforms/services are used by each user 10, social media information of each user 10 from such platforms, etc.), digital value capture information (e.g., information representing each users' 10 preferences in being engaged digitally, virtually, etc.), product propensity (e.g., likely interest for each user 10 in one or more financial products, services, groups, etc.), and personal preferences (e.g., financial goals and objectives, life stages, financial stages, financial preference information, geographical information, etc.). User declared data may include data that a user 10 surrenders, such as demographic details (e.g., gender, date of birth, marital status, dwelling, occupation, employer, school, etc.), social information (e.g., identities of family and friends, social media account information, etc.), banking and financial information (e.g., financial account information, preferred currency, and banking relationship(s), relationships with financial institutions, financial products held, etc.). User declared data may also include a user's 10 explicit consent for the system 100 and/or processor 200 to access and/or track the data obtainable from the user declared data, such as account activity and/or the like.

Information received by the main interface 210 may also include, but is not limited to, financial product data. Financial product data may include product tenor (e.g., amount of time until maturity for fixed lifespan financial products, investment framework (e.g., amount of time for active trading of unit trusts, etc.), etc.), product risk rating (e.g., risks based on risk of loss of product and complexities of the product), sophisticated product indicator (e.g., 6-point alphabetical scale of N, A, B, C, D, and E, wherein “N” indicates that a product is simple and free of derivatives, “A” denotes the least complexity and “E” denotes the most complex product), financial objective for the financial product, financial preference information (e.g., level of effort, risk capacity, etc.), and conviction rating (e.g., rating of likelihood of performance of the financial product relative to peers, against the same asset class and/or benchmark, over the next period of time (e.g., 18 months, 36 months, etc.), etc.).

Information received by the main interface 210 may also include, but is not limited to, financial personality data. Financial personality data may include savings personality (e.g., attitudes towards savings, types of motivators for savings, savings tendencies and behaviours, etc.), spending personality (e.g., attitudes towards spending, types of motivators for spending, spending tendencies and behaviours, etc.), investment personality (e.g., attitudes towards investing, types of motivators for investing, investment tendencies and behaviours, etc.), protection personality (e.g., attitudes towards protection (e.g., insurance), types of motivators for protection, protection tendencies and behaviours, etc.), and debt personality (e.g., attitudes towards borrowing and repayment, types of motivators for borrowing and repayment, borrowing and repaying tendencies and behaviours, etc.).

Information received by the main interface 210, including those described above and in the present disclosure, are then provided to one or more other elements of the system 100 including, but not limited to, the user data processor 300, the financial product processor 400, the financial personality processor 500, the product recommendations processor 600, the top picks processor 700, and/or the output interface 220.

### The User Data Processor (e.g., User Data Processor 300).

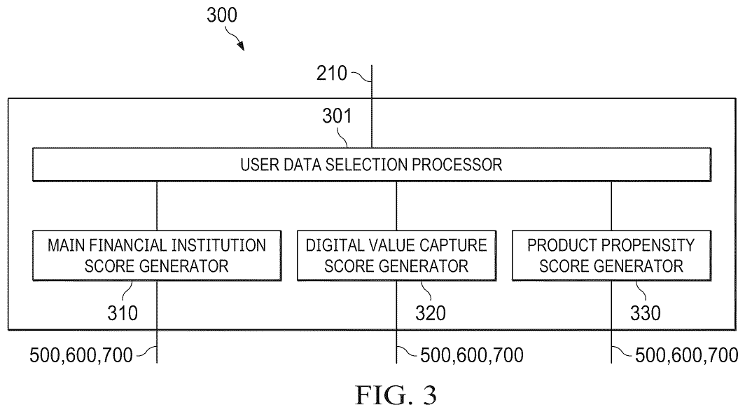

As illustrated in at least FIG. 2 and FIG. 3, the processor 200 includes and/or communicates with one or more user data processors (e.g., user data processor 300). The user data processor 300 is configurable or configured to search for, identify, select, compile, generate, transform, process, assess, and/or otherwise receive the user data received from the main interface 210. In an example embodiment, the user data processor 300 may also search for, identify, select, compile, generate, transform, process, assess, infer, and/or otherwise receive the user's 10 life stage, financial stage, location information, lifestyle, wealth, balance sheet, and/or the like, from the received user data. In another example embodiment, the user data processor 300 may also search for, identify, select, compile, generate, transform, process, assess, infer, and/or otherwise receive information such as frequently visited locations locally and abroad (e.g., outside of the user's 10 registered country/home), financial transactions, behavior patterns, online activity, mobile activity, areas of interest (e.g., wedding, property, from social media usage). The user data processor 300 may also search for, identify, select, compile, generate, transform, process, assess, and/or otherwise receive information such as transaction data (e.g., from debit card, credit card, and/or GIRO transactions, bank transfers and/or financial account activity, settlement instructions, liquidity, etc.) as well as broader data (e.g., SGFinDex data, which includes, among other information, information regarding assets and loan balances for different financial institutions or Government bonds, etc.). In an example embodiment, the user data processor 300 may also search for, identify, select, compile, generate, transform, process, assess, and/or otherwise receive information pertaining to user's 10 digital or online action (e.g., online browsing preferences, digital campaign responses, online financial actions, etc.).

The user data processor 300 may also search for, identify, select, compile, generate, transform, process, assess, and/or otherwise receive information such as which financial institution(s) may be a main financial institution of the user 10, social media information of the user 10, digital value capture information of the user 10, product propensity of the user 10, and personal preferences of the user 10. Such user data are then provided to one or more other elements of the system 100 including, but not limited to, the product recommendations processor 600, the top picks processor 700, and/or the output interface 220.

To perform the actions, functions, processes, and/or methods described above and in the present disclosure, example embodiments of the user data processor 300 include a user data selection processor (e.g., user data selection processor 301). The user data processor 300 also includes a main financial institution score generator (e.g., main financial institution score generator 310). The user data processor 300 also includes a digital value capture score generator (e.g., digital value capture score generator 320). The user data processor 300 also includes a product propensity score generator (e.g., product propensity score generator 330).

These and other elements of the user data processor 300 will now be further described with reference to the accompanying figures.

### The User Data Selection Processor (e.g., User Data Selection Processor 301).

As illustrated in at least FIGS. 2 and 3, the processor 200 includes and/or communicates with one or more user data selection processors (e.g., user data selection processor 301). The user data selection processor 301 is configurable or configured to receive user-related data from the main interface 210. Once received, the user data selection processor 301 may be configurable or configured to select, identify, generate, derive, conclude, infer, and/or otherwise provide information for further processing by the main financial institution score generator 310, the digital value capture score generator 320, and/or the product propensity score generator 330.

In an example embodiment, the user data selection processor 301 is configurable or configured to search for, identify, select, compile, derive, generate, transform, process, assess, infer, conclude, and/or otherwise receive user data.

Such user data may include user (or customer) declared data and/or information generatable, derivable, concludable, inferable, and/or otherwise identifiable or obtainable from user declared data. Examples of such information may include information pertaining to date of birth (DOB), other relevant dates of the user 10, gender, marital status, dwelling, location-based information, occupation, employment information, educational information, frequently visited locations (domestically), frequently visited locations (internationally), lifestyle, preferred currency, family members, friends, inferred wealth, preferred retailers, demographics, sentiment, preferences, behavioural patterns, etc. User declared data may also include a user's 10 explicit or express consent for the system 100 and/or processor 200 to access and/or track the data obtainable from the user declared data, such as account activity and/or the like.

User data in which the user data selection processor 301 searches for, identifies, selects, compiles, derives, generates, transforms, processes, assesses, infers, concludes, and/or otherwise receives may also include financial institution information and/or information generatable, derivable, concludable, inferable, and/or otherwise identifiable or obtainable from financial institution information. Examples of such information may include information pertaining to which financial institutions the user 10 uses, financial account information at one or more financial institutions used by the user 10 (e.g., personal balance sheets, types of accounts, bank account transactions, bank account balances, credit card transactions, credit card balances, credit history, liquidity, retirement plans, which financial institution may be a main financial institution of the user 10 (as further described in the present disclosure), relationships with other financial institutions, corporate banking relationships, etc.), preferred currency, financial products held by the user 10.

User data in which the user data selection processor 301 searches for, identifies, selects, compiles, derives, generates, transforms, processes, assesses, infers, concludes, and/or otherwise receives may also include social media information and/or information generatable, derivable, concludable, inferable, and/or otherwise identifiable or obtainable from social media information. Examples of such information may include information pertaining to which social media platforms, networks, and/or services are used by the user 10, social media information for the user 10 from such platforms, networks, and/or services (e.g., areas of interest, usage and/or degree of activity of the user 10 in the social media platform, network, and/or service, etc.), friends, relationships, and/or connections with others in the social media platform, network, and/or service, social media information for friends, relationships, and/or connections in the social media platform, network, and/or service (e.g., degree of relationships with friends, relationships, and/or connections in the social media platform, network, and/or service; geographical locations of friends, relationships, and/or connections in the social media platform, network, and/or service; areas of interest of friends, relationships, and/or connections in the social media platform, network, and/or service; etc.).

User data in which the user data selection processor 301 searches for, identifies, selects, compiles, derives, generates, transforms, processes, assesses, infers, concludes, and/or otherwise receives may also include digital value capture information, information generatable, derivable, concludable, inferable, and/or otherwise identifiable or obtainable from digital value capture information, and/or information representing each users' 10 preferences in being engaged digitally, virtually, etc. Examples of such information may include information pertaining to transactions conducted by the user 10, digital channels used by the user 10, non-digital channels used by the user 10, investment products purchased by the user 10, frequency of using digital channels (e.g., online banking, etc.), frequency of using non-digital channels (e.g., physical visits to bank branches, etc.), comparisons between digital channel usage vs non-digital channel usage, interactions with and/or responses to digital correspondences (e.g., emails, online advertisements, SMS or text messages, etc.), interactions with and/or responses to non-digital correspondences (e.g., snail mail, flyers, product brochures, etc.), comparisons between digital correspondence interactions vs non-digital correspondence interactions, etc.

User data in which the user data selection processor 301 searches for, identifies, selects, compiles, derives, generates, transforms, processes, assesses, infers, concludes, and/or otherwise receives may also include product propensity information, information generatable, derivable, concludable, inferable, and/or otherwise identifiable or obtainable from product propensity information, and/or information pertaining to a users' 10 likely interest in one or more financial products, services, groups, etc. Examples of such information may include information pertaining to CASA balance, financial institution information of the user 10, balances, income, salary credit amount, etc.

User data in which the user data selection processor 301 searches for, identifies, selects, compiles, derives, generates, transforms, processes, assesses, infers, concludes, and/or otherwise receives may also include personal preferences of the user 10 and/or information generatable, derivable, concludable, inferable, and/or otherwise identifiable or obtainable from personal preferences of the user 10. Examples of such information may include information pertaining to financial goals, financial objectives, life stages, financial stages, risk capacity assessment, level of effort for financial products, geographical information, etc.

Information pertaining to financial goals and financial objectives may include and/or be determined based on, among other things, capital preservation, wealth accumulation, income distribution, retirement, wealth decumulation, education, and/or the like. Financial objectives may be based on product-specific assessments. For example, when a financial product is a unit trust, the financial product (held by the user 10) may be classified under one of various share classes including “accumulative”, “unit”, “cash”, and/or “decumulative” classes. This classification determines the financial objective under which a particular product is classified (e.g., a unit trust would be classified as a “cash” share class if the unit trust distributes dividends in cash, which is particularly useful for a user 10 looking to build recurring income flow).

Information pertaining to life stages of the user 10 may include and/or be determined by based on, among other things, the age and/or network (e.g., family, marital status, existence and/or age of children, etc.) of the user 10. Life stage of the user 10 may be generated as part of the user's 10 set of personal preferences as financial activities and/or habits (e.g., spending, investing, protection plans, etc.) are largely correlated to key life events, especially changes in family (e.g., getting married, having (more) children).

The below Table 1 illustrates an example of life stages that may be generated by the user data selection processor 301 for users 10.

| | Marital Status/ | Age | Youngest |
|---|---|---|---|
| Life Stage | Dependant | (years) | child age |
| Baby | | 0-3 | |
| Pre-schooler | | 4-6 | |
| Grade-schooler | | 7-12 | |
| Teenager | | 13-16 | |
| Young Single | Single | 17-34 | No children |
| Established Single | Single | 35-49 | No children |
| Matured Single | Single | 50-62 | No children |
| Family No Kids | Married | >18 | No children |
| Young Family | With dependant | >18 | ≤6 |
| Established Family | With dependant | >18 | 7-17 |
| Matured Family | With dependant | >18 | ≥18 |
| Senior | | ≥62 | |

Information pertaining to financial stages of the user 10 may be information indicative of the financial maturity of the user 10. Financial stage information of the user 10 may include and/or be determined based on key individual financial metrics including cashflow, amount of savings, investment holdings, past investment actions taken, and/or the like. These can be exemplified in the form of financial wellness (e.g., cashflow, amount of electronic funds available), age, investment or growth insurance products held and/or whether any gaps in protection are present. Investment or growth insurance products may include unit trusts, savings plans with built-in investment options, robo- or partially robo-investments, growth insurance plans, and/or the like. Protection gaps may be defined as how much more protection may be needed for the user, and are calculated by tallying the user's information (e.g., life stage, expenses and/or needs, number of years of support required, financial obligations such as loans, etc.) against the user's existing (i.e., purchased) protection coverage to determine any shortfall in coverage. Financial stage information of the user 10 may be classified by the user data selection processor 301 into one or more categories.

The below Table 2 illustrates an example of financial stage information generated by the user data selection processor 301 and illustrative profiles of users 10 in such financial stages.

| | | | Knowledge |
|---|---|---|---|
| Financial Stage | Demographics | Financial Wellness | (Actions Taken) |
| Cashflow challenged | | Negative cashflow on | |
| | | average in the last | |
| | | 12 mo | |
| Starter | | Positive net cashflow in | |
| (positive cashflow, | | the last 12 mo; <3 mo | |
| insufficient e-funds) | | worth of total e-funds | |
| | | in the last 12 mo | |
| Starter | | Positive net cashflow in | No investment or |
| (positive cashflow, >3-6 | | the last 12 mo; >3 mo | growth insurance |
| months' worth of | | worth of total e-funds | product(s) held |
| e-funds, no action | | in the last 12 mo | |
| taken) | | | |
| Intermediate | | Positive net cashflow in | One category of |
| | | the last 12 mo; >3 mo | active investment |
| | | worth of total e-funds | or growth |
| | | in the last 12 mo | insurance |
| | | | product(s) held; has |
| | | | gaps in protection |
| Advanced: | Age: <55 | Positive net cashflow in | More than one |
| Accumulation Phase | or >5 yrs before ideal | the last 12 mo; >3 mo | category of active |
| | retirement age | worth of total e-funds | investment or |
| | | in the last 12 mo | growth insurance |
| | | | product(s) held; |
| | | | well-covered in |
| | | | protection |
| Advanced: Pre-retiree | Age: 55-65 | Positive net cashflow in | |
| Phase | or | the last 12 mo; >3 mo | |
| | 5 years before ideal | worth of total e-funds | |
| | retirement age | in the last 12 mo | |
| Advanced: | Reached retirement | | |
| Decumulation Phase | age | | |
| Traders | | | Brokerage account |
| | | | holders; active |
| | | | traders; no other |
| | | | managed |
| | | | investment |
| | | | products |

Information pertaining to risk capacity of the user 10 may include and/or be determined by based on, among other things, information obtained through a questionnaire, or the like, that is answered by the user 10. Responses for each question may carry a score, weighted score, or the like, and an aggregated score may tabulated by the user data selection processor 301 once the questionnaire is completed. Based on the aggregated score, the user 10 may fall into one of a number of risk profiles. For example, the user 10 may fall into one of 6 risk profiles: from C0 to C5. Each response to each question may be ascribed a risk rating indicating the maximum risk appetite of the user 10.

The below Table 3 illustrates an example of how the user data selection processor 301 may ascribe a risk rating to a response to a question. This question pertains to the level of average potential investment loss that is acceptable to the user 10.

| Response selection | Capped risk profile |
|---|---|
| 0% capital loss | Capped at C0 - Preservation |
| 4% minimal capital loss | Capped at C1 - Defensive |
| 10% small capital loss | Capped at C2 - Conservative |
| 16% moderate capital loss | Capped at C3 - Moderate |
| 36% high capital loss | Capped at C4 - Balanced |
| >36% significant capital loss | C5 - Aggressive |

Information pertaining to level of effort of the user 10 may include and/or be determined by based on, among other things, information pertaining to and/or indicative of the level of effort that the user 10 may be willing to put into managing investments, including monitoring, reviewing, researching, interacting, etc. Information pertaining to level of effort may be determined through a questionnaire, or the like, that is answered by the user 10.

Once the user data selection processor 301 searches for, identifies, selects, compiles, derives, generates, transforms, processes, assesses, infers, concludes, and/or otherwise receives user data, including those described above and in the present disclosure, the user data selection processor 301 provides such user data to the main financial institution score generator 310, the digital value capture score generator 320, the product propensity score generator 330, and/or one or more other elements of the system 100 or processor 200 for further processing. For example, as described in the present disclosure, the user data selection processor 301 provides user data to the main financial institution score generator 310 to generate main financial institution scores for the user 10. The user data selection processor 301 also provides user data to the digital value capture score generator 320 to generate digital value capture scores for the user 10. The user data selection processor 301 also provides user data to the product propensity score generator 320 to generate product propensity scores for the user 10.

### The Main Financial Institution Score Generator (e.g., Main Financial Institution Score Generator 310).

As illustrated in at least FIG. 2, the processor 200 includes and/or communicates with a main financial institution generator (e.g., main financial institution generator 310). The main financial institution generator 310 is configurable or configured to communicate with the user data selection processor 301 and/or one or more other elements of the system 100.

In an example embodiment, the main financial institution generator 310 is configurable or configured to generate a financial institution score for each financial institution used by the user 10 (as identified by the user data selection processor 301 and/or one or more other elements of the system 100 and/or processor 200). The main financial institution generator 310 is also configurable or configured to generate a financial institution ranking, or the like, by comparing the financial institution score generated for each financial institution and ranking the financial institutions based on the comparing of the financial institution scores of the financial institutions. In an example embodiment, the main financial institution generator 310 identifies, sets, appoints, and/or otherwise designates the financial institution with the highest or top rank to be the main (or primary) financial institution of the user 10.

In an example embodiment, the main financial institution generator 310 performs the above based on user data and/or information received from the user data selection processor 301 and/or one or more other elements of the system 100, including financial information, financial institution information, and/or information generatable, derivable, concludable, inferable, and/or otherwise identifiable or obtainable from financial information, financial institution information, and/or any other information received from the user data selection processor 301. For example, the received information may include financial interaction information including, but not limited to, information pertaining to deposits, investments, channels used, liabilities (e.g., loans), assets, products, balances of one or more financial accounts held by the user 10, usage of each financial institution (e.g., usage of financial institution products (e.g., credit cards, unsecured loans, housing loans), investing through each financial institution, purchase of insurance through each financial institution, usage of each financial institution's payment products, usage of each financial institution's services (e.g., participating in certain cashback programmes), having financial accounts with each financial institution), personal balance sheets, types of accounts, bank account transactions, credit card transactions, credit card balances, credit history, liquidity, retirement plans, which financial institution may be a main financial institution of the user 10 (as further described in the present disclosure), relationships with other financial institutions, corporate banking relationships, etc.), preferred currency, financial products held by the user 10, and/or the like. This received user data may also include non-financial interaction information including, but not limited to, usage of various types of services (e.g., fund transfer, payments, withdrawals, logins, enquires, updating particulars etc.) offered through various financial institution touchpoints (e.g. Automated Teller Machines (ATMs), self-service financial service machines, physical branches, cashpoints, Internet banking portals, mobile banking portals, digital wallets, phone banking).

The main financial institution generator 310 is then configurable or configured to perform searches for all the financial institutions in which the user 10 has at least one financial account (or obtain such information from the user data selection processor 301) (e.g., if such information is not provided by the user 10 and/or identified by the user data selection processor 301). For each financial institution of the user 10 having at least one financial account (e.g., savings account, checking account, etc.), the main financial institution generator 310 is configurable or configured to generate a financial institution score for the financial institution.

In generating a financial institution score for each financial institution of the user 10, the main financial institution generator 310 is configurable or configured to generate a total inflow of value into each of the financial accounts held by the user 10 in each financial institution for a period of time. The main financial institution generator 310 is also configurable or configured to generate a total outflow of value out of each of the financial accounts held by the user 10 in each financial institution for the period of time. The main financial institution generator 310 is then configurable or configured to generate an inflow/outflow ratio for each financial account held by the user 10 for the period of time, based on the generated total inflow and outflow of value.

Alternatively or in addition, the main financial institution generator 310 is configurable or configured to generate a total inflow of value into each financial institution of the user 10 for a period of time. The main financial institution generator 310 is also configurable or configured to generate a total outflow of value out of each financial institution of the user 10 for the period of time. The main financial institution generator 310 is then configurable or configured to generate an inflow/outflow ratio for each financial institution of the user 10 for the period of time, based on the generated total inflow and outflow of value.

In generating a financial institution score for each financial institution of the user 10, the main financial institution generator 310 is configurable or configured to identify all recurring payments made by each financial account held by the user 10 in each financial institution for the period of time. The main financial institution processor 310 is also configurable or configured to identify all non-recurring payments made by each financial account held by the user 10 in each financial institution for the period of time.

Alternatively or in addition, the main financial institution generator 310 is configurable or configured to identify all recurring payments made by each financial institution of the user 10 for a period of time. The main financial institution generator 310 is also configurable or configured to identify all non-recurring payments made by each financial institution of the user 10 for the period of time.

The main financial institution generator 310 generates a financial institution score for each financial institution for the user 10 based on at least one or more of the following: the inflow/outflow ratio for each financial account held by the user 10, the inflow/outflow ratio for each financial institution of the user 10, the identified recurring payments for each financial account held by the user 10, the identified recurring payments for each financial institution of the user 10, the identified non-recurring payments for each financial account held by the user 10, and/or the identified non-recurring payments for each financial institution of the user 10. The main financial institution generator 310 then determines a financial institution ranking for the period of time by comparing the financial institution score for each of the financial institutions, and ranking the financial institutions based on the comparison. Through this ranking, a main financial institution for the user 10 for the period of time is identified, set, appointed, and/or otherwise designated by the main financial institution generator 310.

In an example embodiment, the main financial institution generator 310 is configurable or configured to determine the user's 10 holistic bank usage based on, among other things, the user's 10 product holdings, balances, interactions, and payments. For example, the main financial institution generator 310 may search for, identify, select, compile, derive, generate, transform, process, assess, infer, conclude, and/or otherwise receive information on, based on, and/or pertaining to the user's 10 number of product holdings (e.g., products held, and other services and indicators), volume of balances (e.g., assets, liabilities, CUL ratio, and inflow/outflow ratio), number of interactions (e.g., with main financial institution and other financial institutions), frequency of payments (e.g., everyday payments, recurring payments, episodic payments, inflows, etc.), frequency of inflows (e.g., salary, bonuses, reimbursements, commission, interest earned, etc.). The main financial institution generator 310 may combine and/or include this information in the generating of the financial institution score, including performing assessments of importance (or relative importance) of each information using, for example, logistic regression so as to compute a total weighted score for overall bank usage for the user 10.

In an embodiment, the main financial institution generator 310 determines the user's 10 banking needs based on the user's 10 life stage and affordability. Life stage may be determined based on, among other things, the user's 10 age and network (e.g., family). Affordability may be determined based on, among other things, the user's 10 declared income and wealth and the user's 10 inferred income and wealth (as provided by the user data selection processor 301). The user's 10 banking needs are determined by mirroring with other users 10, including normalizing the data and removing outliers, for all relevant microsegments (e.g., different life stages and affordability combinations).

Once the main financial institution generator 310 performs the above, including the generating of the financial institution score for each financial institution used by the user 10, the financial institution ranking, or the like, and the main (or primary) financial institution of the user 10, the main financial institution generator 310 is then configurable or configured to provide such information to the financial personality processor 500, the product recommendations processor 600, and/or the top picks processor 700. For example, information pertaining to the main financial institution of the user 10 may be provided to the product recommendations processor 600 for use in generating product recommendations for the user 10. Information pertaining to the main financial institution of the user 10 may also be provided to the top picks processor for use in generating top picks for the user 10.

### The Digital Value Capture Score Generator (e.g., Digital Value Capture Score Generator 320).

As illustrated in at least FIG. 2, the processor 200 includes and/or communicates with a digital value capture score generator (e.g., digital value capture score generator 320). The digital value capture score generator 320 is configurable or configured to communicate with the user data selection processor 301 and/or one or more other elements of the system 100.

In an example embodiment, the digital value capture score generator 320 is configurable or configured to generate a digital value capture score based on user data and/or other information received from the user data selection processor 301 and/or one or more other elements of the system 100. The digital value capture score is a score representing the user's 10 preferences in being engaged digitally. The digital value capture score generator 320 generates the digital value capture score based on transactions by the user 10, channels used by the user 10, investment products purchased by the user 10, frequency of use of digital channels (e.g., online banking) versus non-digital channels (e.g., physical visits to bank branches), and/or interactions with digital correspondence (e.g., e-mails) versus non-digital correspondences (e.g., snail mail). The digital value capture score may also be generated based on other information including, but not limited to, social media information, digital value capture information, information on personal preferences of the user 10, and/or information generatable, derivable, concludable, inferable, and/or otherwise identifiable or obtainable from social media information, digital value capture information, information on personal preferences of the user 10, and/or any other information received from the user data selection processor 301. Examples of social media information used by the digital value capture score generator 320 may include information pertaining to which social media platforms, networks, and/or services are used by the user 10, social media information for the user 10 from such platforms, networks, and/or services (e.g., areas of interest, usage and/or degree of activity of the user 10 in the social media platform, network, and/or service, etc.), friends, relationships, and/or connections with others in the social media platform, network, and/or service, social media information for friends, relationships, and/or connections in the social media platform, network, and/or service (e.g., degree of relationships with friends, relationships, and/or connections in the social media platform, network, and/or service; geographical locations of friends, relationships, and/or connections in the social media platform, network, and/or service; areas of interest of friends, relationships, and/or connections in the social media platform, network, and/or service; etc.). Examples of digital value capture information used by the digital value capture score generator 320 may include information pertaining to transactions conducted by the user 10, digital channels used by the user 10, non-digital channels used by the user 10, investment products purchased by the user 10, frequency of using digital channels (e.g., online banking, etc.), frequency of using non-digital channels (e.g., physical visits to bank branches, etc.), comparisons between digital channel usage vs non-digital channel usage, interactions with and/or responses to digital correspondences (e.g., emails, online advertisements, SMS or text messages, etc.), interactions with and/or responses to non-digital correspondences (e.g., snail mail, flyers, product brochures, etc.), comparisons between digital correspondence interactions vs non-digital correspondence interactions, etc. Examples of personal preference information of the user 10 used by the digital value capture score generator 320 may include information pertaining to financial goals, financial objectives, life stages, financial stages, financial preference information, geographical information, etc.

Once the digital value capture score generator 320 performs the above, including the generating of the digital value capture score for the user 10, the digital value capture score generator 320 is then configurable or configured to provide such information to the financial personality processor 500, the product recommendations processor 600, and/or the top picks processor 700. For example, information pertaining to the digital value capture score of the user 10 may be provided to the financial personality processor 500 for use in generating the financial personality of the user 10. Information pertaining to the digital value capture score of the user 10 may also be provided to the product recommendations processor 600 for use in generating product recommendations for the user 10. Information pertaining to the digital value capture score of the user 10 may also be provided to the top picks processor for use in generating top picks for the user 10.

### The Product Propensity Score Generator (e.g., Product Propensity Score Generator 330).

As illustrated in at least FIG. 2, the processor 200 includes and/or communicates with a product propensity score generator (e.g., product propensity score generator 330). The product propensity score generator 330 is configurable or configured to communicate with the user data selection processor 301 and/or one or more other elements of the system 100.

In an example embodiment, the product propensity score generator 330 is configurable or configured to generate a product propensity score for one or more financial products for the user 10. The product propensity score is a score representing the user's 10 likely interest in the one or more financial products. The product propensity score generator 330 generates the product propensity score based on user data and/or information received from the user data selection processor 301 and/or one or more other elements of the system 100, including product propensity information and/or information generatable, derivable, concludable, inferable, and/or otherwise identifiable or obtainable from. Examples of such information include, but are not limited to, CASA (Current Account Savings Account) balance, the financial institution rankings and financial institution scores, balances of one or more financial accounts held by the user 10, income of the user 10, salary of the user 10, demographic information, past financial product(s) held, past financial activities (e.g., spendings, savings, etc.), taxation amounts, and/or the like. The product propensity score may also be generated based on other information including, but not limited to, financial information, financial institution information, and/or information generatable, derivable, concludable, inferable, and/or otherwise identifiable or obtainable from financial information, financial institution information, and/or any other information received from the user data selection processor 301. For example, the received information may include financial interaction information including, but not limited to, information pertaining to deposits, investments, channels used, liabilities (e.g., loans), assets, products, balances of one or more financial accounts held by the user 10, usage of each financial institution (e.g., usage of financial institution products (e.g., credit cards, unsecured loans, housing loans), investing through each financial institution, purchase of insurance through each financial institution, usage of each financial institution's payment products, usage of each financial institution's services (e.g., participating in certain cashback programmes), having financial accounts with each financial institution), personal balance sheets, types of accounts, bank account transactions, credit card transactions, credit card balances, credit history, liquidity, retirement plans, which financial institution may be a main financial institution of the user 10 (as further described in the present disclosure), relationships with other financial institutions, corporate banking relationships, etc.), preferred currency, financial products held by the user 10, and/or the like. This received user data may also include non-financial interaction information including, but not limited to, usage of various types of services (e.g., fund transfer, payments, withdrawals, logins, enquires, updating particulars etc.) offered through various financial institution touchpoints (e.g. Automated Teller Machines (ATMs), self-service financial service machines, physical branches, cashpoints, Internet banking portals, mobile banking portals, digital wallets, phone banking).

The product propensity score generator 330 is configurable or configured to assess how each of the above information influences the user's 10 interest in a particular financial product. For example, the user's 10 age may have a negative influence on interest in a Dependant's Protection Scheme but a positive influence on interest in Annuities.

Once the product propensity score generator 330 performs the above, including the generating of the product propensity score for one or more financial products for the user 10, the product propensity score generator 330 is then configurable or configured to provide such information to the financial personality processor 500, the product recommendations processor 600, and/or the top picks processor 700. For example, information pertaining to the product propensity score of the user 10 may be provided to the financial personality processor 500 for use in generating the financial personality of the user 10. Information pertaining to the product propensity score of the user 10 may also be provided to the product recommendations processor 600 for use in generating product recommendations for the user 10. Information pertaining to the product propensity score of the user 10 may also be provided to the top picks processor for use in generating top picks for the user 10.

### The Financial Product Processor (e.g., Financial Product Processor 400).

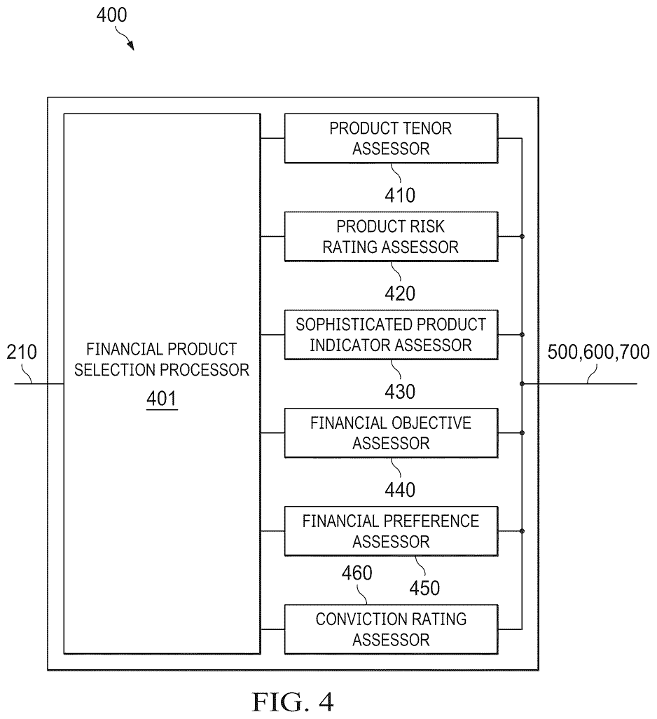

As illustrated in at least FIG. 2 and FIG. 4, the processor 200 includes and/or communicates with one or more financial product processors (e.g., financial product processor 400). The financial product processor 400 is configurable or configured to search for, identify, select, compile, generate, transform, process, assess, and/or otherwise receive financial product information and/or other information (including information received from the main interface 210 and/or one or more other elements of the system 100). For example, the financial product processor 400 may also search for, identify, select, compile, generate, transform, process, assess, infer, and/or otherwise receive information pertaining to product tenor (e.g., amount of time until maturity for fixed lifespan financial products, investment framework (e.g., amount of time for active trading of unit trusts, etc.), etc.), product risk rating (e.g., risks based on risk of loss of product and complexities of the product), sophisticated product indicator (e.g., 6-point alphabetical scale of N, A, B, C, D, and E, wherein “N” indicates that a product is simple and free of derivatives, “A” denotes the least complexity and “E” denotes the most complex product), financial objective for the financial product, financial preference information (e.g., level of effort, risk capacity, etc.), and conviction rating (e.g., rating of likelihood of performance of the financial product relative to peers, against the same asset class and/or benchmark, over the next period of time (e.g., 18 months, 36 months, etc.), etc.).

In an example embodiment, the financial product processor 400 identifies, selects, compiles, generates, transforms, processes, assesses, and/or otherwise provides such financial product information to one or more other elements of the system 100 including, but not limited to, the financial personality processor 500, the product recommendations processor 600, the top picks processor 700, and/or the output interface 220.

To perform the actions, functions, processes, and/or methods described above and in the present disclosure, example embodiments of the financial product processor 400 include a financial product selection processor (e.g., financial product selection processor 401). The financial product processor 400 also includes a product tenor assessor (e.g., product tenor assessor 410). The financial product processor 400 also includes a product risk rating assessor (e.g., product risk rating assessor 420). The financial product processor 400 also includes a sophisticated product indicator assessor (e.g., sophisticated product indicator assessor 430). The financial product processor 400 also includes a financial objective assessor (e.g., financial objective assessor 440). The financial product processor 400 also includes a financial preference assessor (e.g., financial preference assessor 450). The financial product processor 400 also includes a conviction rating assessor (e.g., conviction rating assessor 460).

These and other elements of the financial product processor 400 will now be further described with reference to the accompanying figures.

### The Financial Product Selection Processor (e.g., Financial Product Selection Processor 401).

As illustrated in at least FIGS. 2 and 4, the financial product processor 400 includes and/or communicates with one or more user financial product selection processors (e.g., financial product selection processor 401). The financial product selection processor 401 is configurable or configured to search for, identify, select, compile, generate, transform, process, assess, and/or otherwise receive financial product data and/or other information from the main interface 210 and/or one or more other elements of the system 100 for further processing by the product tenor assessor 410, product risk rating assessor 420, sophisticated product indicator assessor 430, financial objective assessor 440, financial preference assessor 450, and/or conviction rating assessor 460.

Such financial product data may include, but is not limited to, information pertaining to product tenor, product risk rating, sophistication level of the product (or sophisticated product indicator), financial objective, financial preference, conviction ratings, and/or information generatable, derivable, concludable, inferable, and/or otherwise identifiable or obtainable from product tenor, product risk rating, sophistication level of the product (or sophisticated product indicator), financial objective, financial preference, and/or conviction ratings. In an example embodiment, the pool of financial product(s) of which real-time data is generated by the financial product selection processor 401 may be onboarded into the system 100 after manual governance assessments.

Once the financial product selection processor 401 searches for, identifies, selects, compiles, derives, generates, transforms, processes, assesses, infers, concludes, and/or otherwise receives financial product data, including those described above and in the present disclosure, the financial product selection processor 401 provides such financial product data to the product tenor assessor (e.g., product tenor assessor 410), product risk rating assessor (e.g., product risk rating assessor 420), sophisticated product indicator assessor (e.g., sophisticated product indicator assessor 430), financial objective assessor (e.g., financial objective assessor 440), financial preference assessor (e.g., financial preference assessor 450), and/or conviction rating assessor (e.g., conviction rating assessor 460) for further processing.

### The Product Tenor Assessor (e.g., Product Tenor Assessor 410).

As illustrated in at least FIGS. 2 and 4, the financial product processor 400 includes and/or communicates with a product tenor assessor (e.g., product tenor assessor 410). The product tenor assessor 410 is configurable or configured to communicate with the financial product selection processor 401 and/or one or more other elements of the system 100.

In an example embodiment, the product tenor assessor 410 is configurable or configured to perform a product tenor assessment for one or more financial products for the user 10. Product tenor may be prescribed to financial products based on, among other things, each product's features, length of time before the financial product expires, etc. In an example embodiment, financial products with a fixed lifespan (e.g., endowment plans, bonds, structured notes, etc.) may be prescribed a tenor based on the number years to maturity. Financial products without fixed lifespans (e.g., unit trusts) may be prescribed based on an investment framework which is manually reviewed periodically (e.g., annually) and/or whenever there are material changes, and updated in the financial product data processor 208.

Once the product tenor assessor 410 performs the product tenor assessment for the one or more financial products for the user 10, the product tenor assessor 410 provides such product tenor assessment information to the financial personality processor 500, the product recommendations processor 600, and/or the top picks processor 700 for further processing.

### The Product Risk Rating Assessor (e.g., Product Risk Rating Assessor 420).

As illustrated in at least FIGS. 2 and 4, the financial product processor 400 includes and/or communicates with a product risk rating assessor (e.g., product risk rating assessor 420). The product risk rating assessor 420 is configurable or configured to communicate with the financial product selection processor 401 and/or one or more other elements of the system 100.

In an embodiment, the product risk rating assessor 420 is configurable or configured to perform a product risk rating assessment for one or more financial products for the user 10. Product risk rating assessments may include, but is not limited to, a 2-dimensional framework where the first dimension reflects the potential loss of the product and the second dimension reflects the complexity of the product (as reflected by the sophisticated product indicator). The product risk rating assessor 420 is configurable or configured to consider both price and issuer risk based on Peak Pre-settlement Credit Exposure (PPCE) in its calculation and calibration of its methodology of potential loss. PPCE represents the maximum loss for a transaction, forecasted at a pre-specified confidence level of 97.5% (e.g., loss in a near worst case scenario). In order to calibrate the PPCE for a product risk rating, PPCE is first calculated based on a pre-selected set of benchmark asset classes with long term historical movement to check that the financial product remains fairly stable over market cycles.

In an example embodiment, the PPCE is calculated using the following equation:

$$PPCE = 1 - {e}^{\{ ( r - {σ}^{2} / 2 ) \cdot t - z \cdot σ \cdot √ t \}}$$

where “r”=risk-free rate, “σ”=260-day annualized volatility, “t”=time horizon and “z”=1.96 (representing 97.5% confidence).

In an example embodiment, the product risk rating may be classified into one or more categories. For example, the product risk rating may be categorized into 5 categories (e.g., P1 to P5) based on the PPCE range.

The below Table 4 illustrates an example of how a product risk rating corresponds to PPCE range.

| Risk classification | PPCE range |
|---|---|
| P1 | 0%-8% |
| P2 | >8%-20% |
| P3 | >20%-32% |
| P4 | >32%-72% |
| P5 | >72% |

Once the product risk rating assessor 420 performs the product risk rating assessment for the one or more financial products for the user 10, the product risk rating assessor 420 provides such product risk rating assessment information to the financial personality processor 500, the product recommendations processor 600, and/or the top picks processor 700 for further processing.

### The Sophisticated Product Indicator Assessor (e.g., Sophisticated Product Indicator Assessor 430).

As illustrated in at least FIGS. 2 and 4, the financial product processor 400 includes and/or communicates with a sophisticated product indicator assessor (e.g., sophisticated product indicator assessor 430). The sophisticated product indicator assessor 430 is configurable or configured to communicate with the financial product selection processor 401 and/or one or more other elements of the system 100.

In an embodiment, the sophisticated product indicator assessor 430 is configurable or configured to perform an assessment of a level of sophistication for one or more financial products for the user 10 so as to arrive at a sophisticated product indicator. The sophisticated product indicator is an indication of the complexity or sophistication of a financial product. In an example embodiment, the complexity or sophistication of a financial product may be rated on a point scale. For example, the complexity or sophistication of a financial product may be rated on a 6-point scale: N, A, B, C, D, E, where an “N” rating may indicate that a product is simple and free of derivatives; and products which include derivatives and/or complex product features may fall between an “A” and “E” rating, where an “A” rating may indicate the least complexity and an “E” rating may indicate the most complexity. The sophisticated product indicator may be for use to identify investment products that are generally non-traditional and highly complex.

Once the sophisticated product indicator assessor 430 performs the assessment of the level of sophistication of the financial products, including arriving at a sophisticated product indicator for the one or more financial products for the user 10, the sophisticated product indicator assessor 430 provides such sophisticated product indicator information to the financial personality processor 500, the product recommendations processor 600, and/or the top picks processor 700 for further processing.

### The Financial Objective Assessor (e.g., Financial Objective Assessor 440).

As illustrated in at least FIGS. 2 and 4, the financial product processor 400 includes and/or communicates with a financial objective assessor (e.g., financial objective assessor 440). The financial objective assessor 440 is configurable or configured to communicate with the financial product selection processor 401 and/or one or more other elements of the system 100.

In an embodiment, the financial objective assessor 440 is configurable or configured to perform an assessment of a financial objective for one or more financial products for the user 10. Each financial product is ascribed a primary financial objective out of a selection of financial objectives that the financial product can best fulfill, depending on the feature(s) and function(s) of the financial product.

Once the financial objective assessor 440 performs the assessment of the financial objective of the financial products, the financial objective assessor 440 provides such financial objective information to the financial personality processor 500, the product recommendations processor 600, and/or the top picks processor 700 for further processing.

### The Financial Preference Assessor (e.g., Financial Preference Assessor 450).

As illustrated in at least FIGS. 2 and 4, the financial product processor 400 includes and/or communicates with a financial preference assessor (e.g., financial preference assessor 450). The financial preference assessor 450 is configurable or configured to communicate with the financial product selection processor 401 and/or one or more other elements of the system 100.

In an embodiment, the financial preference assessor 450 is configurable or configured to search for, identify, select, compile, generate, transform, process, assess, and/or otherwise receive a level of effort willingly expended by users 10 to determine an appropriate financial product. For example, a level of effort a user 10 may willingly expend may be determined based on how often the user 10 reviews or monitors held investments, and/or based on the user's 10 responses to a questionnaire asking questions to that effect.

In another embodiment, the financial preference assessor 450 is configurable or configured to search for, identify, select, compile, generate, transform, process, assess, and/or otherwise receive a risk capacity of users 10. Risk capacity may be determined based on user information (e.g., demographics), behaviours (e.g., products purchased), financial wellness (e.g., account balance), and/or the like, or based on the user's 10 responses to a questionnaire measuring risk tolerance, the user's 10 knowledge and confidence of the user's future financial situation, etc., For example, a user 10 with, among other things, high risk tolerance and healthy financial wellness may be assessed to have high risk capacity.

In another embodiment, the financial preference assessor 450 is configurable or configured to search for, identify, select, compile, generate, transform, process, assess, and/or otherwise receive a preference of the user 10 on investments, insurance, savings, and other aspects of financial planning. Preference on investments, insurance, savings, and other aspects of financial planning may be determined based on customer declared data, behaviours (e.g., products purchased), financial wellness (e.g., account balance), risk capacity, and/or the like. For example, a user 10 with, among other things, low risk capacity and little spending behaviour may be assessed to prefer more savings-related products.

In another embodiment, the financial preference assessor 450 is configurable or configured to search for, identify, select, compile, generate, transform, process, assess, and/or otherwise receive a determination of a financial product's suitability and/or preferrability based the profile (e.g., user information, financial wellness, preference on investments, etc.) of the user 10. For example, a financial product that is high-risk and high-reward may be assessed to be suited for a user 10 with healthy financial wellness and a preference for volatile investments.

Once the financial preference assessor 450 performs the assessment so as to arrive at financial preference information for the financial products, the preference assessor 450 provides such financial preference information to the financial personality processor 500, the product recommendations processor 600, and/or the top picks processor 700 for further processing.

### The Conviction Rating Assessor (e.g., Conviction Rating Assessor 460).

As illustrated in at least FIGS. 2 and 4, the financial product processor 400 includes and/or communicates with a conviction rating assessor (e.g., conviction rating assessor 460). The conviction rating assessor 460 is configurable or configured to communicate with the financial product selection processor 401 and/or one or more other elements of the system 100.

In an example embodiment, the conviction rating assessor 460 is configurable or configured to search for, identify, select, compile, generate, transform, process, assess, and/or otherwise receive a conviction rating for the financial product. A conviction rating represents the determination of a financial product's likeliness to perform relative to their peers, against their asset class and/or benchmark, over the next 18 to 36 months, and/or the like. In an example embodiment, each financial product is evaluated based on its qualitative aspects such as its fund manager(s)′ track record, experience, investing strategy in maximizing returns, past and present performance, long-term returns potential, and/or the like. This evaluation may be performed manually and/or via one or more elements of the processor 200.

In an example embodiment, the conviction rating may be assigned in the form of intensity, or the like, based on a range of assessed conviction levels. For example, the conviction rating may be assigned based on a range that ranges from Low to Strong Positive.

The below Table 5 illustrates an example of conviction ratings for financial products.

| Conviction Level | Conviction Rating |
|---|---|
| Strong Positive | + + + + |
| Positive | + + + |
| Neutral | + + |
| Low | + |

Once the conviction rating assessor 460 performs the assessment so as to arrive at a conviction rating for financial products, the conviction rating assessor 460 provides such conviction rating information to the financial personality processor 500, the product recommendations processor 600, and/or the top picks processor 700 for further processing.

### The Financial Personality Processor (e.g., Financial Personality Processor 500).

As illustrated in at least FIG. 2, the processor 200 includes and/or communicates with one or more financial personality processors (e.g., financial personality processor 500). The financial personality processor 500 is configurable or configured to communicate with the main interface 210 and/or one or more other elements of the system 100.

In an example embodiment, the financial personality processor 500 is configurable or configured to search for, identify, select, compile, generate, transform, process, assess, and/or otherwise receive a financial personality of the user 10. The financial personality may be based on a psychometric assessment, or the like, of the user 10 for use in determining personality and/or behavioral traits on various aspects of financial planning and/or management. The financial personality of the user 10 may be generated based on multiple facets including, but not limited to, savings personality, spending personality, investment personality, protection personality, debt personality, and/or the like. For example, the psychometric assessment may measure the user's attitudes, motivations, tendencies, and behaviours surrounding various financial aspects. The user's historical behaviours and attitudes may also be used, alone or in conjunction with the psychometric assessment, to predict or adjust the user's financial personality.

Once the financial personality processor 500 performs the assessment so as to arrive at a financial personality for the user 10, the financial personality processor 500 provides such financial personality information to the product recommendations processor 600 and/or the top picks processor 700 for further processing.

### The Product Recommendations Processor (e.g., Product Recommendations Processor 600).

As illustrated in at least FIG. 2, the processor 200 includes and/or communicates with a product recommendations processor (e.g., product recommendations processor 600 or product recommendation processor 600). The product recommendation processor 600 is configurable or configured to perform a variety of functions. For example, the product recommendation processor 600 is configurable or configured to search for, identify, select, compile, generate, transform, process, assess, and/or otherwise receive one or more product recommendations (e.g., financial product recommendations) for the user 10. The product recommendations processor 600 is also configurable or configured to communicate with the main interface 210, the user data processor 300, the financial product processor 400, the financial personality processor, the top picks processor 700, and/or one or more other elements of the system 100.

For example, the product recommendations processor 600 is configurable or configured to receive user data and/or other information from the user data processor 300. More specifically, the product recommendations processor 600 is configurable or configured to receive user declared data, financial institution information, social media information, digital value capture information, product propensity information, and/or personal preferences information (e.g., information pertaining to financial goals, financial objectives, life stages, financial stages, risk capacity assessment, financial preference, geographical information, etc.), as processed by the user data selection processor 301 (as described in the present disclosure). The product recommendations processor 600 is also configurable or configured to receive the financial institution scores for each financial institution used by the user 10, the financial institution ranking of the financial institutions used by the user 10, and the main (or primary) financial institution of the user 10, as processed by the main financial institution generator 310 (as described in the present disclosure). The product recommendations processor 600 is also configurable or configured to receive the digital value capture score of the user 10, as processed by the digital value capture score generator 320 (as described in the present disclosure). The product recommendations processor 600 is also configurable or configured to receive the product propensity score of the user 10, as processed by the product propensity score generator 330 (as described in the present disclosure). The product recommendations processor 600 is also configurable or configured to receive financial product data, as processed by the financial product selection processor 401 (as described in the present disclosure). The product recommendations processor 600 is also configurable or configured to receive product tenor assessment information, as processed by the product tenor assessor 410 (as described in the present disclosure). The product recommendations processor 600 is also configurable or configured to receive product risk rating information, as processed by the product risk rating assessor 420 (as described in the present disclosure). The product recommendations processor 600 is also configurable or configured to receive sophisticated product indicator information, as processed by the sophisticated product indicator assessor 430 (as described in the present disclosure). The product recommendations processor 600 is also configurable or configured to receive financial preference information, as processed by the financial preference assessor 450 (as described in the present disclosure). The product recommendations processor 600 is also configurable or configured to receive conviction rating information, as processed by the conviction rating assessor 460 (as described in the present disclosure). The product recommendations processor 600 is also configurable or configured to receive financial personality information, as processed by the financial personality processor 500 (as described in the present disclosure).

In an example embodiment, the product recommendations processor 600 is configurable or configured to generate product recommendations for the user 10. Such product recommendations are generated based on one or more of the information received or receivable by the product recommendations processor 600 including, but not limited to, one or more of the following: user declared data, financial institution information, social media information, digital value capture information, product propensity information, personal preferences information (e.g., information pertaining to financial goals, financial objectives, life stages, financial stages, financial preference, geographical information, etc.), financial institution scores for each financial institution used by the user 10, the financial institution ranking of the financial institutions used by the user 10, the main (or primary) financial institution of the user 10, the digital value capture score of the user 10, the product propensity score of the user 10, financial product data (as processed by the financial product selection processor 401), product tenor assessment information, product risk rating information, sophisticated product indicator information, financial preference information, conviction rating information, and/or financial personality information.

In some example embodiments, the product recommendations processor 600 is also configurable or configured to generate product recommendations for the user 10 based on top picks generated by the top picks generator 700).

Once the product recommendations processor 600 generates one or more product recommendations for the user 10, the product recommendations processor 600 provides the one or more product recommendations for the user 10 to the output interface 220. In example embodiments, the product recommendations processor 600 may also provide the one or more product recommendations for the user 10 to the top picks processor 700 for further processing.

### The Top Picks Generator (e.g., Top Picks Generator 700).

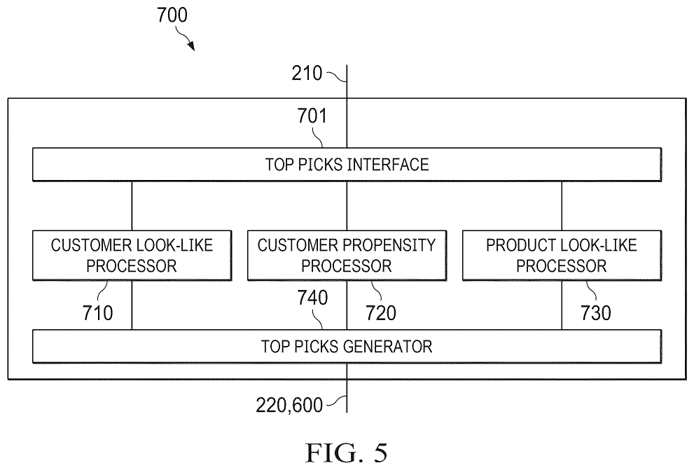

As illustrated in at least FIG. 2 and FIG. 5, the processor 200 includes and/or communicates with one or more top picks generators (e.g., top picks generator 700 or top pick generator 700). The top picks generator 700 is configurable or configured to perform a variety of functions. For example, the top picks processor 700 is configurable or configured to search for, identify, select, compile, generate, transform, process, assess, and/or otherwise receive one or more top picks (of financial products) for the user 10. The top picks processor 700 is also configurable or configured to communicate with the main interface 210, the user data processor 300, the financial product processor 400, the financial personality processor, the product recommendations processor 600, and/or one or more other elements of the system 100.

The top picks processor 700 is configurable or configured to receive user data and/or other information from the user data processor 300. For example, the top picks processor 700 may be configurable or configured to receive user declared data, financial institution information, social media information, digital value capture information, product propensity information, and/or personal preferences information (e.g., information pertaining to financial goals, financial objectives, life stages, financial stages, financial preference, geographical information, etc.), as processed by the user data selection processor 301 (as described in the present disclosure). The top picks processor 700 may also be configurable or configured to receive the financial institution scores for each financial institution used by the user 10, the financial institution ranking of the financial institutions used by the user 10, and the main (or primary) financial institution of the user 10, as processed by the main financial institution generator 310 (as described in the present disclosure). The top picks processor 700 may also be configurable or configured to receive the digital value capture score of the user 10, as processed by the digital value capture score generator 320 (as described in the present disclosure). The top picks processor 700 may also be configurable or configured to receive the product propensity score of the user 10, as processed by the product propensity score generator 330 (as described in the present disclosure). The top picks processor 700 may also be configurable or configured to receive financial product data, as processed by the financial product selection processor 401 (as described in the present disclosure). The top picks processor 700 may also be configurable or configured to receive product tenor assessment information, as processed by the product tenor assessor 410 (as described in the present disclosure). The top picks processor 700 may also be configurable or configured to receive product risk rating information, as processed by the product risk rating assessor 420 (as described in the present disclosure). The top picks processor 700 may also be configurable or configured to receive sophisticated product indicator information, as processed by the sophisticated product indicator assessor 430 (as described in the present disclosure). The top picks processor 700 may also be configurable or configured to receive financial preference information, as processed by the financial preference assessor 450 (as described in the present disclosure). The top picks processor 700 may also be configurable or configured to receive conviction rating information, as processed by the conviction rating assessor 460 (as described in the present disclosure). The top picks processor 700 may also be configurable or configured to receive financial personality information, as processed by the financial personality processor 500 (as described in the present disclosure).

In an example embodiment, the top picks processor 700 is configurable or configured to generate top picks for the user 10. Such top picks may be generated based on a customer look-like assessment, customer propensity assessment, product look-like assessment, and/or one or more of the information received or receivable by the top picks processor 700 including, but not limited to, one or more of the following: user declared data, financial institution information, social media information, digital value capture information, product propensity information, personal preferences information (e.g., information pertaining to financial goals, financial objectives, life stages, financial stages, financial preference, geographical information, etc.), financial institution scores for each financial institution used by the user 10, the financial institution ranking of the financial institutions used by the user 10, the main (or primary) financial institution of the user 10, the digital value capture score of the user 10, the product propensity score of the user 10, financial product data (as processed by the financial product selection processor 401), product tenor assessment information, product risk rating information, sophisticated product indicator information, financial preference information, conviction rating information, financial personality information, and/or product recommendations (as generated by the product recommendations processor 600). For example, top picks generated by the top picks generator 700 may be financial products selected based on two or more of the following assessments: customer look-like assessment, customer propensity assessment, and product look-like assessment.

To perform the actions, functions, processes, and/or methods described above and in the present disclosure, example embodiments of the top picks generator 700 include a top picks interface (e.g., top picks interface 701). The top picks generator 700 also includes a customer look-like processor (e.g., customer look-like processor 710). The top picks generator 700 also includes a customer propensity processor (e.g., customer propensity processor 720). The top picks generator 700 also includes a product look-like processor (e.g., product look-like processor 730).

These and other elements of the top picks generator 700 will now be further described with reference to the accompanying figures.

### The Top Picks Interface (e.g., Top Picks Interface 701).

As illustrated in at least FIGS. 2 and 5, the top picks generator 700 includes and/or communicates with one or more user top picks interface (e.g., top picks interface 701). The top picks interface 701 is configurable or configured to search for, identify, select, compile, generate, transform, process, assess, and/or otherwise receive user data (e.g., from the user data processor 300), financial product data (e.g., from the financial product processor 400), financial personality information (e.g., from the financial personality processor 500), product recommendations (e.g., from the product recommendations processor 600) and/or one or more other elements of the system 100 for further processing by the customer look-like processor 710, customer propensity processor 720, and product look-like processor 730.

### The Customer Look-Like Processor (e.g., Customer Look-Like Processor 710).

As illustrated in at least FIG. 5, an example embodiment of the top picks generator 700 includes one or more customer look-like processors (e.g., customer look-like processor 710). The customer look-like processor 710 is configurable or configured to generate a list of top picks of financial products based on one or more other users 10 who ‘look like’, are similar or identical to, have similar user data (as generated by the user data processor 300), have similar financial product data (as generated by the financial product processor 400), have similar financial personality information (as generated by the financial personality processor 500), and/or have similar product recommendations (as generated by the product recommendations processor 600) as the user 10 (also referred to herein as the “customer look-like model”).

Users 10 are first classified into one of two categories: Existing-to-Products (ETP) and New-to-Products (NTP). For example, if the user 10 is in the ETP category, the customer look-like processor 710 may process other users who are also classified as ETP. Other attributes used to determine other users who ‘look like’ the user 10 may include, but are not limited to, demographics (e.g., life stage, age, etc.), bank relationships (e.g., financial institution rankings, balances in accounts held by the users 10, etc.), product transaction behavior (e.g., transaction frequency, recency, value, etc.), product holdings, risk capacity assessment, and/or the like.

The similarity (or look-like) among users 10 classified as ETP may be primarily determined by historical relevant product uptake behaviors. For example, users 10 may be clustered with other users 10 with the most similar behaviors, thus forming one or more user clusters. In each cluster, the most popular financial products purchased by other users in that cluster may be identified as top picks for the user 10.

The similarity (or look-like) among users 10 classified as NTP may be primarily determined by commonalities in demographic profiles and/or other financial metrics, including assets and liabilities, cashflow, and/or the like. Users 10 are clustered similarly to ETP users into one or more user clusters. The financial products with the highest transaction volume and/or revenue within the user's cluster may be identified as top picks for the user 10.

### The Customer Propensity Processor (e.g., Customer Propensity Processor 720).

As illustrated in at least FIG. 3, an example embodiment of the top picks generator 700 includes one or more customer propensity processors (e.g., customer propensity processor 720). The customer propensity processor 720 is configurable or configured to generate a list of top picks of financial products based on the user's 10 likelihood of taking up available funds (also referred to herein as the “customer propensity model”).

The customer propensity processor 720 is configurable or configured to cluster funds into two or more fund clusters. This clustering may additionally factor in user information (e.g., from the user data processor 300 and/or the financial personality processor 500) and determine the likelihood of the user 10 taking up any particular fund from each fund cluster.

### The Product Look-Like Processor (e.g., Product Look-Like Processor 730).

As illustrated in at least FIG. 3, an example embodiment of the top picks generator 700 includes one or more product look-like processors (e.g., product look-like processor 730). The product look-like processor 730 is configurable or configured to generate a list of top picks of financial products based on similarities between financial product(s) previously purchased by the user 10, financial product(s) the user 10 has previously expressed interest in purchasing, and/or product recommendations from the product recommendations generator 600 (also referred to herein as the “product look-like model”).

In an example embodiment, the product look-like processor 730 may be configurable or configured to select top picks for users classified as ETP (e.g., due to the basis of previous purchase or interest in financial product(s)). Product similarity may be primarily determined based on product meta-attributes (e.g., in the case of a unit trust, meta attributes include fund house, estimated price, asset type, asset subtypes, tenor, minimum investment amount, Regular Savings Plan (RSP) indicator (e.g., indication of whether a product offers an option for monthly recurring purchase), etc.).

Each product may be matched with a selection of products that most ‘look like’ it based on similarities in meta-attributes. For example, if the user has purchased a particular product in the past, up to 5 of the most relevant products may be prioritized as top picks for the user under the product look-like model.

### The Top Picks Generator (e.g., Top Picks Generator 740).

As illustrated in at least FIG. 5, an example embodiment of the top picks generator 700 includes one or more top picks generators (e.g., top picks generator 740). The top picks generator 740 is configurable or configured to generate a final list of top picks of financial products based on list of top picks generated by the customer look-like processor 710, the customer propensity processor 720, and/or the product look-like processor 730.

For example, the top picks generator 740 may receive the lists of top picks from the customer look-like processor 710, the customer propensity processor 720, and the product look-like processor 730, and generate a final list of top picks based on all three lists of top picks. Alternatively, the top picks generator 740 may receive the lists of top picks from the customer look-like processor 710, the customer propensity processor 720, and the product look-like processor 730, and generate a final list of top picks based on at least two of the lists of top picks.

### The Output Interface (e.g., Output Interface 220).

As illustrated in at least FIG. 2, the processor 200 includes and/or communicates with one or more output interfaces (e.g., output interface 220).

In an example embodiment, the output interface 220 is configurable or configured to receive product recommendations for the user 10 from the product recommendations processor 600. The output interface 220 is then configurable or configured to send to, make available to, display to, store for, and/or otherwise provide to the user 10 the product recommendations. Alternatively or in addition, the output interface 220 is configurable or configured to store the product recommendations for the user 10 in the database 20.

In an example embodiment, the output interface 220 is also configurable or configured to receive top lists of financial products for the user 10 from the top lists processor 700. The output interface 220 is then configurable or configured to send to, make available to, display to, store for, and/or otherwise provide to the user 10 the top lists of financial products. Alternatively or in addition, the output interface 220 is configurable or configured to store the top lists of financial products for the user 10 in the database 20.

In an example embodiment, the output interface 220 is also configurable or configured to receive other information from other elements of the system 100, including those from the main interface 210, user data processor 300, financial product processor 400, and/or financial personality processor 500. The output interface 220 is then configurable or configured to send to, make available to, display to, store for, and/or otherwise provide to the user 10 such information. Alternatively or in addition, the output interface 220 is configurable or configured to store such information in the database 20.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Also, as referred to herein, a processor, device, computing device, telephone, phone, mobile device, server, generator, subsystem, and/or controller, may be any processor, computing device, and/or communication device, and may include a virtual machine, computer, node, instance, host, or machine in a networked computing environment.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. For example, a description of a technology, or the like, in the “Background” shall not be construed as an admission that such technology is prior art to any example embodiments in this disclosure. Furthermore, any reference in this disclosure to an “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method for managing user financial information, the method comprising:
performing a main financial institution processing, the main financial institution processing including:
searching, for a first user, all financial institutions in which the first user has at least one financial account, including a first financial institution and a second financial institution;
for each of the financial institutions located by the search:
generating a total inflow of value into all financial accounts held by the first user for a first period of time, including a first total inflow of value and a second total inflow of value, the first total inflow of value being the total inflow of value into all financial accounts held by the first user in the first financial institution for the first period of time, the second total inflow of value being the total inflow of value into all financial accounts held by the first user in the second financial institution for the first period of time;
generating a total outflow of value out of all financial accounts held by the first user for the first period of time, including a first total outflow of value and a second total outflow of value, the first total outflow of value being the total outflow of value out of all financial accounts held by the first user in the first financial institution for the first period of time, the second total outflow of value being the total outflow of value out of all financial accounts held by the first user in the second financial institution for the first period of time;
generating an inflow/outflow ratio for the first user for the first period of time based on the generated total inflow of value and the generated total outflow of value, including a first inflow/outflow ratio and a second inflow/outflow ratio, the first inflow/outflow ratio being a ratio of the first total inflow of value to the first total outflow of value, the second inflow/outflow ratio being a ratio of the second total inflow of value to the second total outflow of value;
identifying all recurring payments made by all financial accounts held by the first user for the first time period, including a first set of recurring payments and a second set of recurring payments, the first set of recurring payments being all recurring payments made by all financial accounts held by the first user in the first financial institution for the first period of time, the second set of recurring payments being all recurring payments made by all financial accounts held by the first user in the second financial institution for the first period of time;
identifying all non-recurring payments made by all financial accounts held by the first user for the first time period, including a first set of non-recurring payments and a second set of non-recurring payments, the first set of non-recurring payments being all non-recurring payments made by all financial accounts held by the first user in the first financial institution for the first period of time, the second set of non-recurring payments being all non-recurring payments made by all financial accounts held by the first user in the second financial institution for the first period of time; and
generating a financial institution score for the first user based on at least one of the inflow/outflow ratio, the identified recurring payments, and the non-recurring payments, including a first financial institution score and a second financial institution score, wherein the first financial institution score is generated based on at least one of the first inflow/outflow ratio, the first set of recurring payments, and the first set of non-recurring payments, wherein the second financial institution score is generated based on at least one of the second inflow/outflow ratio, the second set of recurring payments, and the second set of non-recurring payments; and
determining a financial institution ranking for the first user for the first period of time, the ranking financial institution for the first user for the first time period determined by:
comparing the financial institution score for each of the financial institutions located by the search, including the first financial institution score and the second financial institution score; and
ranking the financial institutions located by the search based on the comparing; and
generating one or more product recommendations for the first user, the one or more product recommendations for the first user generated based on at least one of the following:
one or more of the financial institution scores generated for the first user; and
the financial institution ranking for the first user.

2. The method of claim 1, further comprising:
selecting a main financial institution for the first user for the first period of time, the main financial institution for the first user for the first period of time being the financial institution located by the search having the highest ranking, wherein the generating of the one or more product recommendations is further based on the selected main financial institution for the first user for the first period of time.

3. The method of claim 1, further comprising:
selecting a main financial institution for the first user for the first period of time, the main financial institution for the first user for the first period of time being the financial institution located by the search having the highest financial institution score, wherein the generating of the one or more product recommendations is further based on the selected main financial institution for the first user for the first period of time.

4. The method of claim 1,
wherein the first financial institution is ranked higher than the second financial institution when the first financial institution score is greater than the second financial institution score.

5. The method of claim 1,
wherein the financial institution score for each of the financial institutions located by the search is further based on one or more of the following: financial interactions of the financial accounts in the financial institution, deposits into the financial accounts in the financial institution, investments in the financial accounts in the financial institution, loans in the financial accounts in the financial institution, non-financial interactions with the financial institution, balances of the financial accounts in the financial institution, usage level for the financial institution.

6. The method of claim 1, further comprising:
receiving user data for the first user, the user data for the first user including at least one of the following:
one or more customer declared information of the first user, the one or more customer declared information of the first user including information provided by the first user;
one or more financial institution information of the first user, the one or more financial institution information of the first user including information obtainable from one or more financial accounts of one or more financial institutions held by the first user;
one or more social media information of the first user, the one or more social media information of the first user including information obtainable from one or more social media accounts held by the first user; and
one or more personal preference information of the first user, the one or more personal preference information of the first user including financial goals, financial objectives, life stages of the first user, financial stages of the first user, and financial preference of the first user.

7. The method of claim 6,
wherein the generating of the one or more product recommendations is further based on the user data of the first user.

8. The method of claim 1,
wherein the first financial institution score is a score representing the first user's usage of the first financial institution for the first period of time.

9. The method of claim 1,
wherein the second financial institution score is a score representing the first user's usage of the second financial institution for the first period of time.

10. The method of claim 1, further comprising:
generating a digital value capture score for the first user, the digital value capture score for the first user representing the first user's preference in being engaged digitally, the digital value capture score for the first user generated based on at least one of the following: one or more transactions made by the first user, one or more channels used by the first user, one or more investment products purchased by the first user, number of times the first user used digital channels, number of times the first user used non-digital channels, number of times the first user interacted based on digital communications, number of times the first user interacted based on non-digital communications.

11. The method of claim 10,
wherein the generating of the one or more product recommendations is further based on the digital value capture score for the first user.

12. The method of claim 1, further comprising:
generating a product propensity score for the first user, the product propensity score for the first user representing the first user's likely interest in one or more financial products, the product propensity score for the first user generated based on at least one of the following: CASA balance, one or more of the financial institution scores, balances of one or more financial accounts held by the first user, income of the first user.

13. The method of claim 12,
wherein the generating of the one or more product recommendations is further based on the product propensity score for the first user.

14. The method of claim 1, further comprising:
generating real-time financial product information for one or more financial products, the real-time financial product information generated based on at least one of the following: product tenor, product risk rating, level of sophistication of the financial product, financial objective of the financial product, risk capacity assessment of the financial product, conviction rating of the financial product.

15. The method of claim 14,
wherein the generating of the one or more product recommendations is further based on the real-time financial product information.

16. The method of claim 1, further comprising:
generating a financial personality of the first user, the financial personality of the first user being a psychometric assessment of the first user to determine personality and/or behavioral traits on different aspects of financial planning of the first user, the financial personality of the first user generated based on at least one of the following: savings personality of the first user, spending personality of the first user, investment personality of the first user, protection personality of the first user, and debt personality of the first user.

17. The method of claim 16,
wherein the generating of the one or more product recommendations is further based on the financial personality of the first user.

18. The method of claim 1, further comprising:
generating one or more product top picks for the first user from among the one or more product recommendations generated for the first user, the one or more product top picks for the first user generated based on at least one of the following:
a customer look-like model, wherein the customer look-like model ranks financial products based on other users who are similar to the first user;
a customer propensity model, wherein the customer propensity model ranks financial products based on at least one of the following: user demographics, user bank relationship, product transaction behavior, financial product holdings, customer risk assessment; and
product look-like model, wherein the product look-like model ranks financial products based on financial product similarity as compared to financial products previously purchased by the first user and/or financial products of interest to the first user.

19. A method for managing user financial information, the method comprising:
performing a main financial institution processing for a first user, the main financial institution processing for the first user including:
searching, for the first user, all financial institutions in which the first user has at least one financial account, including a first financial institution and a second financial institution;
for each of the financial institutions located by the search, performing at least one of the following:
generating an inflow/outflow ratio for the first user for a first period of time, the generating of the inflow/outflow ratio for the first user for the first period of time including:
generating a total inflow of value into all financial accounts held by the first user for the first period of time, including a first total inflow of value and a second total inflow of value, the first total inflow of value being the total inflow of value into all financial accounts held by the first user in the first financial institution for the first period of time, the second total inflow of value being the total inflow of value into all financial accounts held by the first user in the second financial institution for the first period of time;
generating a total outflow of value out of all financial accounts held by the first user for the first period of time, including a first total outflow of value and a second total outflow of value, the first total outflow of value being the total outflow of value out of all financial accounts held by the first user in the first financial institution for the first period of time, the second total outflow of value being the total outflow of value out of all financial accounts held by the first user in the second financial institution for the first period of time;
generating the inflow/outflow ratio for the first user for the first period of time based on the generated total inflow of value and the generated total outflow of value, including a first inflow/outflow ratio and a second inflow/outflow ratio, the first inflow/outflow ratio being a ratio of the first total inflow of value to the first total outflow of value, the second inflow/outflow ratio being a ratio of the second total inflow of value to the second total outflow of value;
identifying all recurring payments made by all financial accounts held by the first user for the first time period, including a first set of recurring payments and a second set of recurring payments, the first set of recurring payments being all recurring payments made by all financial accounts held by the first user in the first financial institution for the first period of time, the second set of recurring payments being all recurring payments made by all financial accounts held by the first user in the second financial institution for the first period of time; and
identifying all non-recurring payments made by all financial accounts held by the first user for the first time period, including a first set of non-recurring payments and a second set of non-recurring payments, the first set of non-recurring payments being all non-recurring payments made by all financial accounts held by the first user in the first financial institution for the first period of time, the second set of non-recurring payments being all non-recurring payments made by all financial accounts held by the first user in the second financial institution for the first period of time;
generating a financial institution score for the first user based on at least one of the inflow/outflow ratio, the identified recurring payments, and the non-recurring payments, including a first financial institution score and a second financial institution score, wherein the first financial institution score is generated based on at least one of the first inflow/outflow ratio, the first set of recurring payments, and the first set of non-recurring payments, wherein the second financial institution score is generated based on at least one of the second inflow/outflow ratio, the second set of recurring payments, and the second set of non-recurring payments; and
determining a financial institution ranking for the first user for the first period of time, the ranking financial institution for the first user for the first time period determined by:
comparing the financial institution score for each of the financial institutions located by the search, including the first financial institution score and the second financial institution score; and
ranking the financial institutions located by the search based on the comparing; and
generating one or more product recommendations for the first user, the one or more product recommendations for the first user generated based on at least one of the following:
one or more of the financial institution scores generated for the first user; and
the financial institution ranking for the first user.

20. The method of claim 19, further comprising:
selecting a main financial institution for the first user for the first period of time, the main financial institution for the first user for the first period of time being the financial institution located by the search having the highest ranking, wherein the generating of the one or more product recommendations is further based on the selected main financial institution for the first user for the first period of time.

21. The method of claim 19, further comprising:
selecting a main financial institution for the first user for the first period of time, the main financial institution for the first user for the first period of time being the financial institution located by the search having the highest financial institution score, wherein the generating of the one or more product recommendations is further based on the selected main financial institution for the first user for the first period of time.

22. The method of claim 19,
wherein the first financial institution is ranked higher than the second financial institution when the first financial institution score is greater than the second financial institution score.

23. The method of claim 19,
wherein the financial institution score for each of the financial institutions located by the search is further based on one or more of the following: financial interactions of the financial accounts in the financial institution, deposits into the financial accounts in the financial institution, investments in the financial accounts in the financial institution, loans in the financial accounts in the financial institution, non-financial interactions with the financial institution, balances of the financial accounts in the financial institution, usage level for the financial institution.

24. The method of claim 19, further comprising:
receiving user data for the first user, the user data for the first user including at least one of the following:
one or more customer declared information of the first user, the one or more customer declared information of the first user including information provided by the first user;
one or more financial institution information of the first user, the one or more financial institution information of the first user including information obtainable from one or more financial accounts of one or more financial institutions held by the first user;
one or more social media information of the first user, the one or more social media information of the first user including information obtainable from one or more social media accounts held by the first user; and
one or more personal preference information of the first user, the one or more personal preference information of the first user including financial goals, financial objectives, life stages of the first user, financial stages of the first user, and financial preference of the first user.

25. The method of claim 24,
wherein the generating of the one or more product recommendations is further based on the user data of the first user.

26. The method of claim 19,
wherein the first financial institution score is a score representing the first user's usage of the first financial institution for the first period of time.

27. The method of claim 19,
wherein the second financial institution score is a score representing the first user's usage of the second financial institution for the first period of time.

28. The method of claim 19, further comprising:
generating a digital value capture score for the first user, the digital value capture score for the first user representing the first user's preference in being engaged digitally, the digital value capture score for the first user generated based on at least one of the following: one or more transactions made by the first user, one or more channels used by the first user, one or more investment products purchased by the first user, number of times the first user used digital channels, number of times the first user used non-digital channels, number of times the first user interacted based on digital communications, number of times the first user interacted based on non-digital communications.

29. The method of claim 28,
wherein the generating of the one or more product recommendations is further based on the digital value capture score for the first user.

30. The method of claim 19, further comprising:
generating a product propensity score for the first user, the product propensity score for the first user representing the first user's likely interest in one or more financial products, the product propensity score for the first user generated based on at least one of the following: CASA balance, one or more of the financial institution scores, balances of one or more financial accounts held by the first user, income of the first user.

31. The method of claim 30,
wherein the generating of the one or more product recommendations is further based on the product propensity score for the first user.

32. The method of claim 19, further comprising:
generating real-time financial product information for one or more financial products, the real-time financial product information generated based on at least one of the following: product tenor, product risk rating, level of sophistication of the financial product, financial objective of the financial product, risk capacity assessment of the financial product, conviction rating of the financial product.

33. The method of claim 32,
wherein the generating of the one or more product recommendations is further based on the real-time financial product information.

34. The method of claim 19, further comprising:
generating a financial personality of the first user, the financial personality of the first user being a psychometric assessment of the first user to determine personality and/or behavioral traits on different aspects of financial planning of the first user, the financial personality of the first user generated based on at least one of the following: savings personality of the first user, spending personality of the first user, investment personality of the first user, protection personality of the first user, and debt personality of the first user.

35. The method of claim 34,
wherein the generating of the one or more product recommendations is further based on the financial personality of the first user.

36. The method of claim 19, further comprising:
generating one or more product top picks for the first user from among the one or more product recommendations generated for the first user, the one or more product top picks for the first user generated based on at least one of the following:
a customer look-like model, wherein the customer look-like model ranks financial products based on other users who are similar to the first user;
a customer propensity model, wherein the customer propensity model ranks financial products based on at least one of the following: user demographics, user bank relationship, product transaction behavior, financial product holdings, customer risk assessment; and
product look-like model, wherein the product look-like model ranks financial products based on financial product similarity as compared to financial products previously purchased by the first user and/or financial products of interest to the first user.

37. A method for managing user financial information, the method comprising:
receiving user data for a first user, the user data for the first user including at least one of the following:
one or more customer declared information of the first user, the one or more customer declared information of the first user including information provided by the first user;
one or more financial institution information of the first user, the one or more financial institution information of the first user including information obtainable from one or more financial accounts of one or more financial institutions held by the first user;
one or more social media information of the first user, the one or more social media information of the first user including information obtainable from one or more social media accounts held by the first user; and
one or more personal preference information of the first user, the one or more personal preference information of the first user including financial goals, financial objectives, life stages of the first user, financial stages of the first user, and financial preference of the first user;
performing a main financial institution processing, the main financial institution processing including:
searching, for a first user, all financial institutions in which the first user has at least one financial account, including a first financial institution and a second financial institution;
for each of the financial institutions located by the search:
generating a total inflow of value into all financial accounts held by the first user for a first period of time, including a first total inflow of value and a second total inflow of value, the first total inflow of value being the total inflow of value into all financial accounts held by the first user in the first financial institution for the first period of time, the second total inflow of value being the total inflow of value into all financial accounts held by the first user in the second financial institution for the first period of time;
generating a total outflow of value out of all financial accounts held by the first user for the first period of time, including a first total outflow of value and a second total outflow of value, the first total outflow of value being the total outflow of value out of all financial accounts held by the first user in the first financial institution for the first period of time, the second total outflow of value being the total outflow of value out of all financial accounts held by the first user in the second financial institution for the first period of time;
generating an inflow/outflow ratio for the first user for the first period of time based on the generated total inflow of value and the generated total outflow of value, including a first inflow/outflow ratio and a second inflow/outflow ratio, the first inflow/outflow ratio being a ratio of the first total inflow of value to the first total outflow of value, the second inflow/outflow ratio being a ratio of the second total inflow of value to the second total outflow of value;
identifying all recurring payments made by all financial accounts held by the first user for the first period of time, including a first set of recurring payments and a second set of recurring payments, the first set of recurring payments being all recurring payments made by all financial accounts held by the first user in the first financial institution for the first period of time, the second set of recurring payments being all recurring payments made by all financial accounts held by the first user in the second financial institution for the first period of time;
identifying all non-recurring payments made by all financial accounts held by the first user for the first period of time, including a first set of non-recurring payments and a second set of non-recurring payments, the first set of non-recurring payments being all non-recurring payments made by all financial accounts held by the first user in the first financial institution for the first period of time, the second set of non-recurring payments being all non-recurring payments made by all financial accounts held by the first user in the second financial institution for the first period of time; and
generating a financial institution score for the first user based on at least one of the inflow/outflow ratio, the identified recurring payments, and the non-recurring payments, including a first financial institution score and a second financial institution score, wherein the first financial institution score is generated based on at least one of the first inflow/outflow ratio, the first set of recurring payments, and the first set of non-recurring payments, wherein the second financial institution score is generated based on at least one of the second inflow/outflow ratio, the second set of recurring payments, and the second set of non-recurring payments; and
determining a financial institution ranking for the first user for the first period of time, the ranking financial institution for the first user for the first time period determined by:
comparing the financial institution score for each of the financial institutions located by the search, including the first financial institution score and the second financial institution score; and
ranking the financial institutions located by the search based on the comparing;
generating a digital value capture score for the first user, the digital value capture score for the first user representing the first user's preference in being engaged digitally, the digital value capture score for the first user generated based on at least one of the following: one or more transactions made by the first user, one or more channels used by the first user, one or more investment products purchased by the first user, number of times the first user used digital channels, number of times the first user used non-digital channels, number of times the first user interacted based on digital communications, number of times the first user interacted based on non-digital communications;
generating a product propensity score for the first user, the product propensity score for the first user representing the first user's likely interest in one or more financial products, the product propensity score for the first user generated based on at least one of the following: CASA balance, one or more of the financial institution scores, balances of one or more financial accounts held by the first user, income of the first user;
generating real-time financial product information for one or more financial products, the real-time financial product information generated based on at least one of the following: product tenor, product risk rating, level of sophistication of the financial product, financial objective of the financial product, risk capacity assessment of the financial product, conviction rating of the financial product;
generating a financial personality of the first user, the financial personality of the first user being a psychometric assessment of the first user to determine personality and/or behavioral traits on different aspects of financial planning of the first user, the financial personality of the first user generated based on at least one of the following: savings personality of the first user, spending personality of the first user, investment personality of the first user, protection personality of the first user, and debt personality of the first user;
generating one or more product recommendations for the first user, the one or more product recommendations for the first user generated based on the following:
one or more of the financial institution scores generated for the first user and/or the financial institution ranking for the first user;
the user data for the first user;
the digital value capture score for the first user;
the product propensity score for the first user;
the real-time financial product information for one or more financial products; and
the financial personality of the first user.

38. The method of claim 37, further comprising:
selecting a main financial institution for the first user for the first period of time, the main financial institution for the first user for the first period of time being the financial institution located by the search having the highest ranking, wherein the generating of the one or more product recommendations is further based on the selected main financial institution for the first user for the first period of time.

39. The method of claim 37, further comprising:
selecting a main financial institution for the first user for the first period of time, the main financial institution for the first user for the first period of time being the financial institution located by the search having the highest financial institution score, wherein the generating of the one or more product recommendations is further based on the selected main financial institution for the first user for the first period of time.

40. The method of claim 37,
wherein the financial institution score for each of the financial institutions located by the search is further based on one or more of the following: financial interactions of the financial accounts in the financial institution, deposits into the financial accounts in the financial institution, investments in the financial accounts in the financial institution, loans in the financial accounts in the financial institution, non-financial interactions with the financial institution, balances of the financial accounts in the financial institution, usage level for the financial institution.

41. The method of claim 37, further comprising:
generating one or more product top picks for the first user from among the one or more product recommendations generated for the first user, the one or more product top picks for the first user generated based on at least one of the following:
a customer look-like model, wherein the customer look-like model ranks financial products based on other users who are similar to the first user;
a customer propensity model, wherein the customer propensity model ranks financial products based on at least one of the following: user demographics, user bank relationship, product transaction behavior, financial product holdings, customer risk assessment; and
product look-like model, wherein the product look-like model ranks financial products based on financial product similarity as compared to financial products previously purchased by the first user and/or financial products of interest to the first user.
